(19) United States
(12) Patent Application Publication
(10) Pub. No.: US 2009/0005984 A1
(43) Pub. Date: Jan. 1, 2009

(54) APPARATUS AND METHOD FOR TRANSIT PREDICTION

(76) Inventor: James Roy Bradley, Carp (CA)

Correspondence Address: THE LAW OFFICES OF THOMAS L. ADAMS, 120 EAGLE ROCK AVENUE, Suite 130, EAST HANOVER, NJ, 07936, US

(21) Appl. No.: 12/131,830

(22) Filed: Jun. 2, 2008

Related U.S. Application Data
(60) Provisional application No. 60/941,019, filed on May 31, 2007.

(51) Int. Cl. G01C 21/26

(52) U.S. Cl. 701/213; 701/207; 701/219

(57) ABSTRACT

A transit predictor can be carried by a person or vehicle when attempting to travel through one or more traffic signals that repeatedly change state. The predictor has a data source with a navigational output indicating carrier location and a timing output indicating time. The transit predictor also has a processor with a memory. The processor can record in the memory a plurality of background data from the data source signifying (a) one or more carrier locations where data from the data source indicate the carrier was substantially stationary, and (b) one or more times when data from the data source indicate the carrier ceased being substantially stationary. The processor can algorithmically derive from the plurality of background data a predicted future event that will occur around a predicted time, at a location where, according to the background data, the carrier previously ceased being substantially stationary.

### CROSS-REFERENCES TO RELATED APPLICATIONS

This application claims the benefit of U.S. Provisional Patent Application Ser. No. 60/941,019, filed 31 May 2007, the contents of which are hereby incorporated by reference herein.

### BACKGROUND OF THE INVENTION

1. Field of the Invention

The present invention relates to devices and methods for offering navigational choices, or preferences.

2. Description of the Related Art

Traffic flow can benefit from the availability of enhanced information in a traffic signal environment. This can be in either a traffic signal environment, or a traffic sign environment, or a combination of both.

Present navigation systems permit latitude, longitude, latitude/longitude, latitude/longitude/altitude, rho/theta, rho, theta as well as, a plethora of combinations of these and other reconciliatory methods for offering positional and/or velocity and/or acceleration, and/or jerk information. Common navigational arrangements include: use of a map display, some of which are moving map displays, some of which are supplied with navigational information from a GPS receiver. In this disclosure, it is understood that enhanced techniques such as differential GPS, or the use of pseudolites (essentially ground elements complementing or replacing the space borne constellation of satellites) are to optionally stand in for the primary elements, i.e. GPSS, the satellites or a combination thereof.

According to Webster's Ninth New Collegiate Dictionary (1989), a histogram is “a representation of a frequency distribution by means of rectangles whose widths represent class intervals and whose heights represent corresponding frequencies.” In this specification, for three dimensional histogram representations, the rectangles have a width representing class intervals of position along a traffic path in latitude/longitude space and a width representing class intervals along a line of a latitude/longitude combination, other than collinear with the length representation and whose heights represent frequency of occurrence.

See also U.S. Pat. Nos. 4,559,602; 5,371,678; 5,636,128; 5,911,773; 5,940,010; 6,125,105; 6,317,686; 6,338,021; 6,385,537; 7,054,742; 5,986,575; and 6,243,026; and U.S. Patent application 2006/0055557. See also Bell and MacDonald, “Bus Recognition and Prediction,” Student Final Project CS4721, Columbia University, May 13, 1999.

### SUMMARY OF THE INVENTION

In accordance with the illustrative embodiments demonstrating features and advantages of the present invention, there is provided a transit predictor to be carried by a carrier such as a person or vehicle when attempting to travel through one or more traffic signals that have a repeating change of state. The transit predictor has a data source with a navigational output indicating carrier location and a timing output indicating time. The transit predictor also has a processor with a memory. The processor is coupled to the data source for recording in the memory a plurality of background data from the data source signifying (a) one or more carrier locations where data from the data source indicate the carrier was substantially stationary, and (b) one or more times when data from the data source indicate the carrier ceased being substantially stationary. The processor is operable to algorithmically derive from the plurality of background data a predicted future event that will occur around a predicted time at a location where, according to the background data, the carrier previously ceased being substantially stationary.

In accordance with another aspect of the invention a predictive method is provided that employs a memory for use with a carrier such as a person or vehicle when attempting to travel through one or more traffic signals that have a repeating change of state. The method includes the steps of recurrently providing a navigational output indicating carrier location and recurrently providing a timing output indicating time. Another step is, using the navigational and the timing outputs, recording in the memory a plurality of background data signifying (a) one or more carrier locations where the carrier was substantially stationary, and (b) one or more times when the carrier ceased being substantially stationary. The method also includes the step of algorithmically deriving from the plurality of background data a predicted future event that will occur around a predicted time at a location where, according to the background data, the carrier previously ceased being substantially stationary.

A disclosed device can enhance navigation by augmenting the outputs of a navigational sensor system. The device has at least one sensor for determining at least one of: a line of position, a velocity, a position in two or three dimensions. The navigational sensor is used in conjunction with a timing mechanism, and a processor to deduce at least one of: when the user is not in motion, when the user is in motion; using the timing mechanism to predict the phases of traffic lights and presenting this information to the user in audible, visible or a combination of both formats. The displayed information can include at least one of: zones of synchronized traffic lights, multiple fields overlaid synchronized states of traffic lights indicated by arrows or the like on underlying moving maps, and the amount of time remaining before a state change (red to green, green to yellow/red), the inability to resolve the traffic light state with available information, or the partial inability to resolve the traffic light state with available information.

In a disclosed method information is provided in a more readily usable format. This method also includes the steps of extracting the information from a database.

Also ongoing, interlaced with the detection and recording of locations of stoppages is the extrapolation of potential positions (optionally taken from a database of validated routes) and continual comparisons of the present position to a position extrapolated ahead. This extrapolated position can be obtained for various amounts of time, 10, 20, 30, 40, 50 seconds, and so on up to so many minutes. All the predicted positions can be compared to locations in the database that are stored (and to a minor extent being stored) in memory. If the system determines that a predicted position is within some threshold of being at a previously recorded location of stoppage (i.e. a previously visited intersection), the time at which the vehicle will arrive there is also predicted. This can be further refined by an ongoing interpolation as well. For example refinements of position can be interpolated for known regular locations e.g. repetitive blocks, arrays, or intersections. Also, knowledge of intersections on either side of an intersection being approached or waited at, can be interpolated and presented to the user.

The system accumulates many qualified data sets. The many data sets are compared on a day-to-day basis, an every second day basis, and an every nth day basis. Examples of these data sets are presupposed patterns such as rush hours, time of weekdays, known resynchronizations, known intervention systems from e.g., EMS, neighborhood boundaries, occupied lanes, holidays, etc., and combinations of such. All such data sets, which can be extrapolated onto a reference date, are used to make predictions of the times at which a traffic light will turn green, for a given day. These predictions are displayed on a moving map display, or added to the data stream from a navigational sensor to such a moving map display, externally or integral to the unit.

A further refinement of this basic method extracts all locations of stoppage in the non-volatile memory and determines which, if any are the furthest forward location in the direction of travel, which is given a temporary assignment of being “at the stop line.”

Another embodiment includes the steps of extracting the information from a database augmented with data from other sources. More specifically the adjunct device for a Global Positioning System integrates information obtained, using at least one rule in a rule based expert system using time as the primary driver for decision information.

The system exploits at least one of: the synchronicity of traffic patterns derived primarily from estimates of traffic, inputs from previous traffic patterns, time of day, day of week, a histogram of findings of traffic congestion, traffic stoppage, distance from traffic signaling elements, previous traffic signal state, traffic signal state, anticipated traffic signal states.

The data stream leaving the navigational sensor is sensed and compared to the previous value. At the point that the vehicle's position is determined to be moving, the time, the latitude and the longitude and optionally the direction of arrival are stored in a database. The data are filtered by location and optionally direction of arrival to determine the points in time that the sensor has re-commenced motion at essentially the same location (intersection). By filtering and comparing all known re-commencements a histogram versus time for suitably close locations can be made. In this way likely possibilities for re-commencement can be extrapolated and from this set a suitably close into the future and suitably close in position (i.e. where you are about to be, and when you are about to arrive there in time) predictions can be made.

By suitable communication of this information to the user, by at least one of display, lights, annunciation, tone output, steering inputs, suggested steering inputs, other vehicle inputs, e.g., turn signals, moving map overlay, optionally via a data link, optionally the Internet, the user can make informed decisions on routing, optionally done by automated means.

By employing devices and methods of the foregoing type, a party can effectively increase the party's understanding of the timing, or at least use thereof, of traffic lights.

In another embodiment the information is added as a color on a moving map display. In this embodiment a moving map display has colored overlay in red, green, yellow indicating preferred routes, optionally these routes are from a set of commonly used routes determined by sensing the position of the sensor habitually. This can be filtered by time of day by time of week.

In another embodiment a sense of position in phase with where the user is in a synchronized traffic system is relayed to the user. It is understood that partial information can also be supplied, i.e. cross street vehicle sensing pads can arrest otherwise main traffic flow but only during certain traffic light phases.

In another embodiment the navigation sensing element, combined with other sensor elements is Kalman filtered to create a navigational solution, passed to the using entity. Kalman filters as applied to navigation can use supplementary sensor information to enhance reliability of estimates of position offered by certain types of sensors (i.e. if GPS is not available then wheel spin and direction is acceptable for a short time, or the like).

In another embodiment the system learns over long periods of time preferred routes.

In another embodiment the system compares current locations to estimated locations of intersections; i.e. it compares all similar locations with the same direction of arrival and estimates the furthest forward stopping location (determines the location of the “white stopping line” at the periphery of the intersection) and initially filters all known stops in the area, (optionally of the same direction of arrival) and uses the ones that are furthest forward.

In another embodiment the system uses the furthest forward information and slightly further back information with a lesser weighting function, optionally with a predetermined time value dependent on position of stop from the estimated location of the intersection; i.e. it makes an estimate of whether the vehicle is the first in line the second in line, the third etc. and then uses a predetermined estimates (perhaps from running average) of the time that the traffic between the user and the intersection takes to get moving after the light has turned green. The weighting function falls off pretty quickly as the traffic ahead of a stopped user could have a large variation in response times to a green light and the system gives better results provided the more refined data is used with greater weighting values; i.e. use all values determined, but water down the values of stoppages unless right at the line.

In another embodiment of the present disclosure all known similar location stoppages (i.e. all stops in all different directions at the same intersection) can be used for estimates of the time at which the light must have turned red; i.e. use up all of the available duty cycle. (Assumptions about essentially opposite directions of arrival permitted the same green time slot can be made.) Additionally it is envisioned that the user can add additional information such as “light that just turned green simultaneously permits left turns” to augment the database in such fashion. In an embodiment of the present disclosure information refined by such is used in such refined fashion for the other aspects of the disclosed system; i.e. once the information is refined and has available the light sequences, that information can be used in the display, annunciations, etc. It can also be accumulated by the expert system by suppositions of time.

In another embodiment of this invention the aforementioned device is coupled to the output of a conventional GPS system, including the time signal, and is displayed as a set of colour tracings overlaid on a moving map display, wherein the colour is an indication of the likelihood of better than average passage possibility.

### BRIEF DESCRIPTION OF THE DRAWINGS

The above description as well as other objects, features, and advantages of the present invention will be more fully appreciated by reference to the following detailed description of presently preferred but nonetheless illustrative embodiments in accordance with the present invention when taken in conjunction with the accompanying drawings, wherein:

FIG. 1 is a schematic block diagram of a device in accordance with principles of the present invention;

FIG. 2 is a perspective view of the device of FIG. 1 packaged as a global positioning system as the navigational sensor, with an auxiliary device as an attachment;

FIG. 3 is a histogram showing one form of organization of the data collected from the device of FIG. 1;

FIG. 4 the histogram of FIG. 3 after positional filtering.

FIG. 5 is a diagram representing traffic signal phasing on separate time lines;

FIG. 6 is an informational flowchart showing operations performed by the device of FIG. 1;

FIGS. 7A and 7B are informational flowcharts supplementing that of FIG. 6 and further showing operations performed by the device of FIG. 1

FIG. 8 is a diagram representing traffic signal phasing on separate time lines and marked with certain attempted intersection crossings;

FIG. 9 is a flowchart illustrating a power down processing for the device of FIG. 1;

FIG. 9B is a schematic block diagram of a circuit that may be used in connection with the device of FIG. 1;

FIG. 10 is an information display developed by the device of FIG. 1 in the form of a map overlaid with the color information at the intersections;

FIG. 11 is an information display that is an alternate to that of FIG. 10;

FIG. 12 shows an information display that is an alternate to that of FIGS. 10 and 11 and that is overlaid with zones of synchronization; and

FIG. 13 shows a moving map of FIG. 12 but modified to show moving zones of synchronization.

### DETAILED DESCRIPTION OF THE PREFERRED EMBODIMENTS

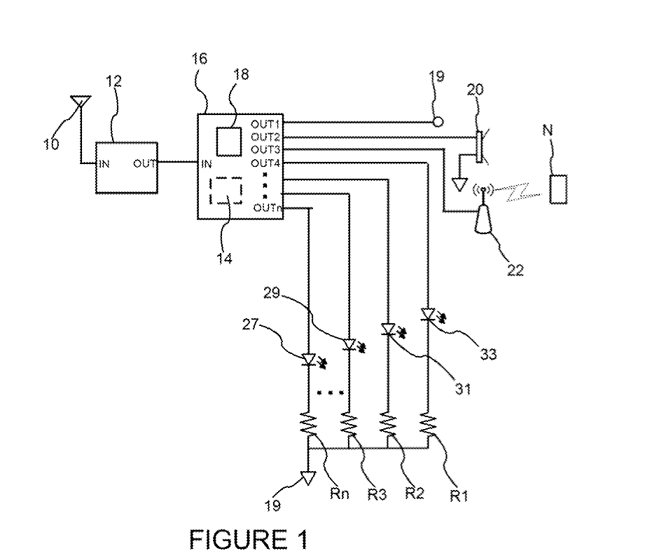

Referring to FIG. 1, a transit predictor is illustrated as a device for offering enhanced navigational information. This transit predictor may be carried by a carrier such as a vehicle or a person and employs a navigational sensor 12 providing a navigation output indicating carrier location. Navigation sensor antenna 10 sends signals to input IN of navigation sensor 12. Navigation sensor 12 is in this embodiment a GPS system with a navigation output OUT connected to input IN of processor 16. Sensor 12 outputs GPS data streams of any one of various types including NMEA (National Marine Electronics Association), whereby the time information is readily available. Instead of conventional GPS, some embodiments may use the GALILEO (European) navigation system, the GLONASS (Russian) navigation system, or the Baidu (Chinese) navigation system. In other embodiments of this invention the navigation sensor may use exclusively or supplementally inertial navigation to determine positional information. Still other embodiments may provide navigational output from one or more of an inertial navigational reference, a LORAN sensor, an Omega navigation system sensor, and an RNAV receiver.

In still other embodiments the navigational sensor may employ a cellphone device that supplies navigational information from cellphone infrastructure. In such cases the system may determine location by triangulation from cell towers, or by using a directional antenna.

Processor 16 has memory 14, which includes volatile and nonvolatile digital memory and can accumulate triples of latitude, longitude and time. The foregoing equipment may be carried in a vehicle, for example, an automobile. In this disclosure the apparatus is self-contained and battery operated.

Processor 16 receives time information either as a timing output from sensor 12 or from another timing device. For example, processor can have its own internal clock or can be connected to a second device such as some other external clock. The devices providing the navigation output and the timing output are collectively referred to as a data source.

Processor 16 is shown having a two-dimensional LCD display 18, herein referred to as an interface. In some embodiments display 18 may be a separate display connected to processor 16.

As described further hereinafter, navigational sensor 12 detects the location, and by taking the difference in a minimum of two different locations can deduce an approximation of velocity. This is an ongoing activity monitored or implemented by processor 16. The system can declare that velocities below a certain magnitude are effectively zero velocity (except that some changes may be treated as small distance increments that are an artifact of update and truncation errors occurring post-stoppage). The system will record in non-volatile memory 14 the time of occurrence, the location, and the direction of arrival (i.e. the sign of the difference in position, which was calculated and used to approximate velocity). Recorded data can be referred to a stopping event (stoppage) and can be correlated to the place and time when a vehicle (carrier) first stopped and when it next moved.

Output OUT1 of processor 16 may be connected to a display as described further hereinafter. Processor outputs OUT2 and OUT3 connect to one terminal of loudspeaker 20 (other terminal grounded) and to transmitter/antenna combination 22, acting as a wireless transceiver to/from a remote network.

This wireless transceiver 22 can establish communications with an external network N. Network N can be an information channel operated by the agency in charge of maintaining traffic signals. Network N can instead be a network of vehicles carrying equipment similar to that described herein. Network N can be accessed in order to download at least one of: (a) supplementary data that can be used to supplement background data stored in memory 14, and (b) a schedule of state changes for one or more traffic signals. Transceiver 22 can also upload to this network N at least one of: (a) time and location of events predicted by processor 16, (b) at least a portion of the background data of memory 14, and (c) information derived from the background data.

Processor outputs OUT4 through OUTn connect to the anodes of LEDs 33, 31, 29, . . . 27, whose cathodes connect to ground through resistors R1, R2, R3, Rn. In some embodiments these LEDs can signal the state or predicted state of certain traffic signals.

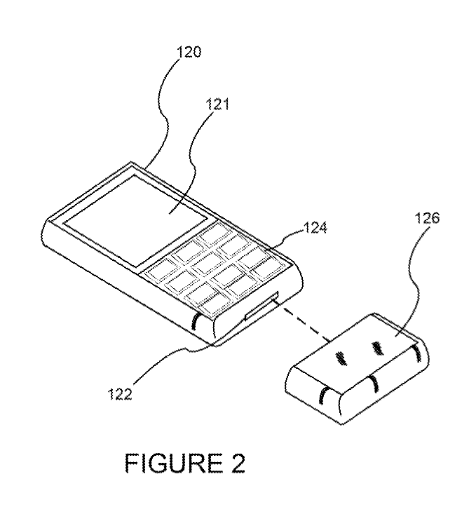

Referring to FIG. 2, previously mentioned navigation sensor (sensor 12 of FIG. 1) is contained within navigation sensor module 120. Module 120 is shown with an interface in the form of keyboard 124 and LCD display 121. In some embodiments keyboard 124 may be used as a user operable device enabling a user to signal observations to the processor (processor 16 of FIG. 1). Module 120 has a data port 122, which is adapted to connect to adjunct enclosure 126 containing the previously mentioned processor (processor 16 of FIG. 1).

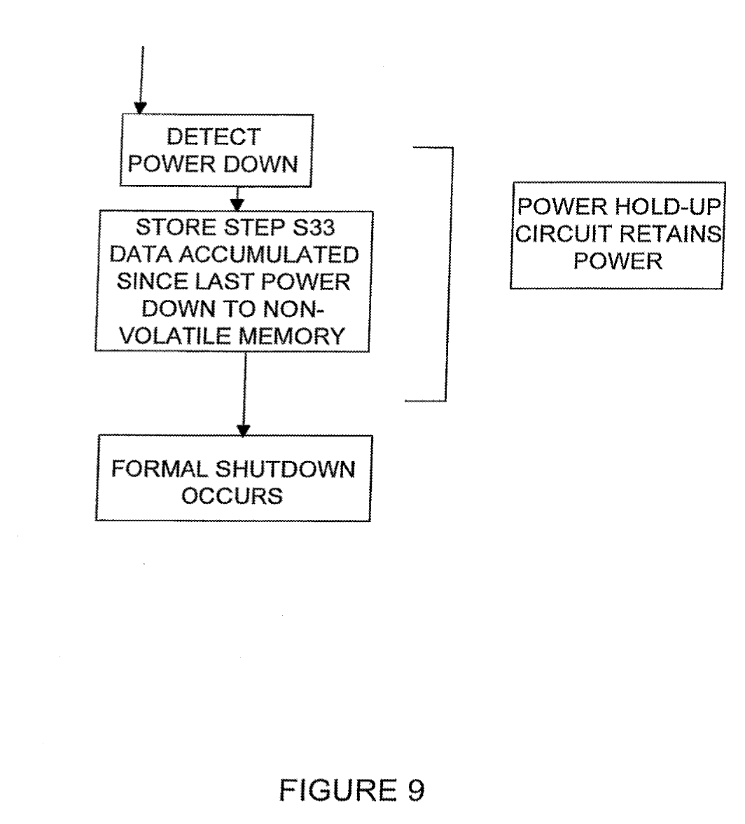

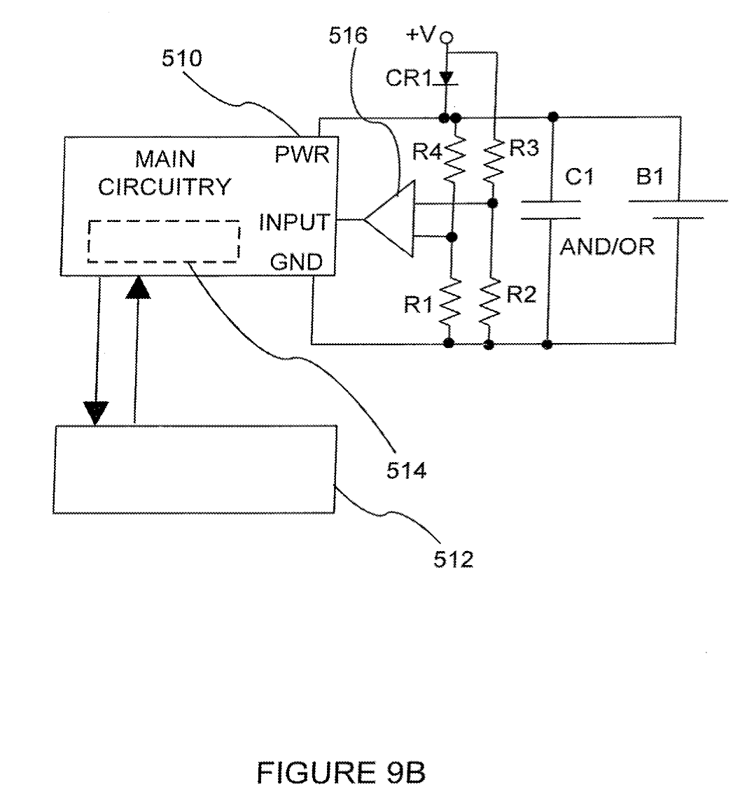

FIG. 9B is a schematic block diagram showing the components of the power down circuitry. Main circuitry 510 (previously shown in FIG. 1) is shown here with volatile memory 514, and non-volatile memory (NVM) 512 (also referred to herein as a volatile and non-volatile section of a memory). External power supply potential +V is connected to the anode of rectifier CR1 whose cathode connects to terminal PWR of main circuit 510. The positive and negative terminals of optional battery B1 or connected to terminals PWR and GND, respectively, of main circuit 510. Optional capacitor C1 is connected in parallel with battery B1. At least one of C1 or B1 or an alternative power source must be present to supply internal power.

Serially connected resistors R1 and R4 form a resistor divider that is connected across battery B1. Serial resistors R2 and R3 are connected between terminals PWR and GND of main circuit 510 to form another resistor divider.

The junction of resistor divider R1/R4 is connected to one input of comparator 516 whose other input connects to the junction of divider R2/R3 in order to act as a power sensor. The output of comparator 516 connects to terminal INPUT of main circuit 510.

As explained further hereinafter the dividers provide an indication of voltage levels that are suitable for processing on the rail voltages V+, or those of C1 or B1.

Before removal of potential +V (i.e., during normal use) the resistor divider R2/R3 is powered by the external power +V and resistor divider R1/R4 is powered along with all other circuitry by V+ via diode CR1 in positive bias. The nodes in the middle of the R2/R3 resistor divider and the R1/R4 resistor divider are input to comparator 516 which in turn detects that node R2/R3 is at a higher voltage than node R1/R4.

Removal of external power V+, reverse biases diode CR1, and in turn removes power to the resistor divider R2/R3 and causes the remaining circuitry to be powered by the internal power source, battery B1 in our example. Removal of power to resistor divider R2/R3 causes voltage at node R2/R3 to be less than voltage at node R1/R4, which in turn is sensed by comparator 516 to provide a signal to terminal INPUT of main circuit 510 (essentially providing a signal to processor 16 of FIG. 1).

Main circuit 510 detects this power down and, as described later in connection with FIG. 9, writes RAM contents 514 to NVM 512. Energy in capacitor C1, or battery B1, is sufficient to completely support this storage process.

Restoration of external power +V, restores power to resistor divider R2/R3, and the remaining circuitry via now positively biased diode CR1. Restoration of power to the resistor divider R2/R3 causes the voltage of the R2/R3 node to be higher than the voltage at the R1/R4 node, which is in turn sensed by comparator 516, sending a corresponding signal to main circuit 510.

This comparator signal supplied to the main circuit 510 causes the contents of the NVM 512 to be written to RAM 514 for use until the power is removed at V+once again.

FIG. 9 is a diagram showing the sequence of actions that the present device/method uses. In FIG. 9 power down action is triggered by removal of the incoming electrical power.

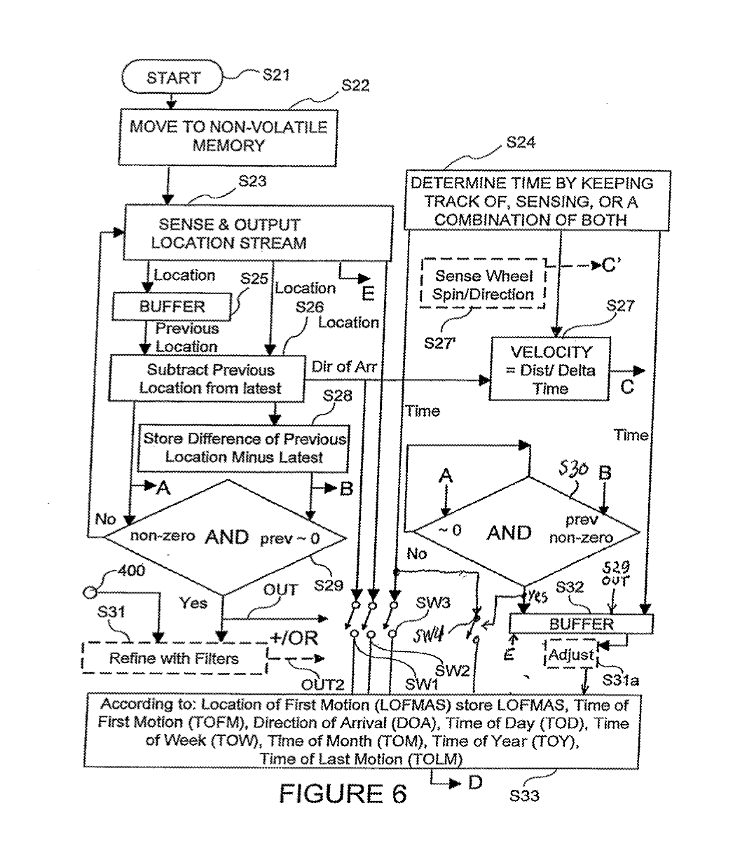

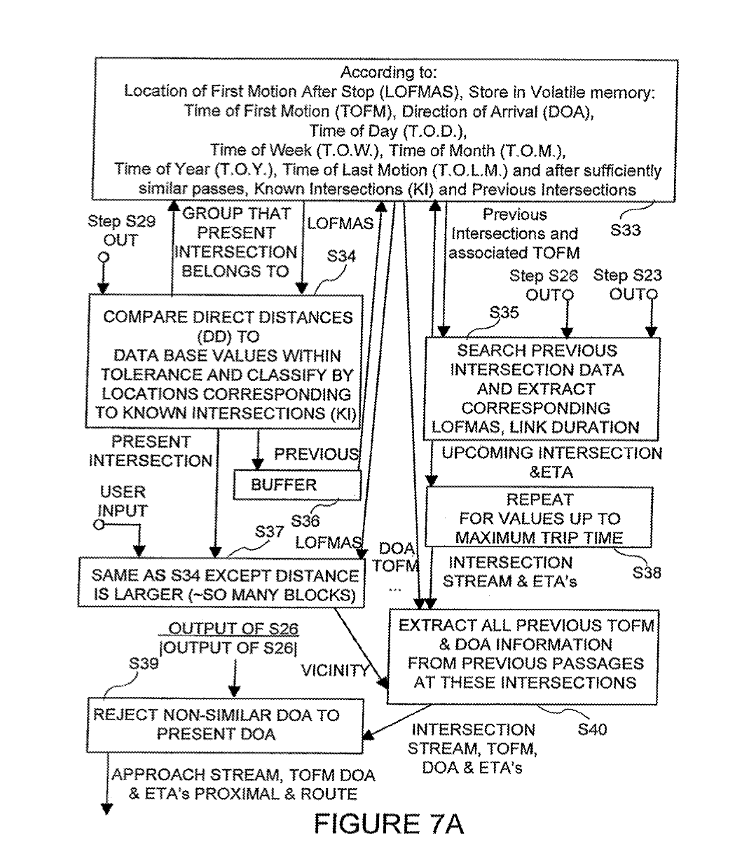

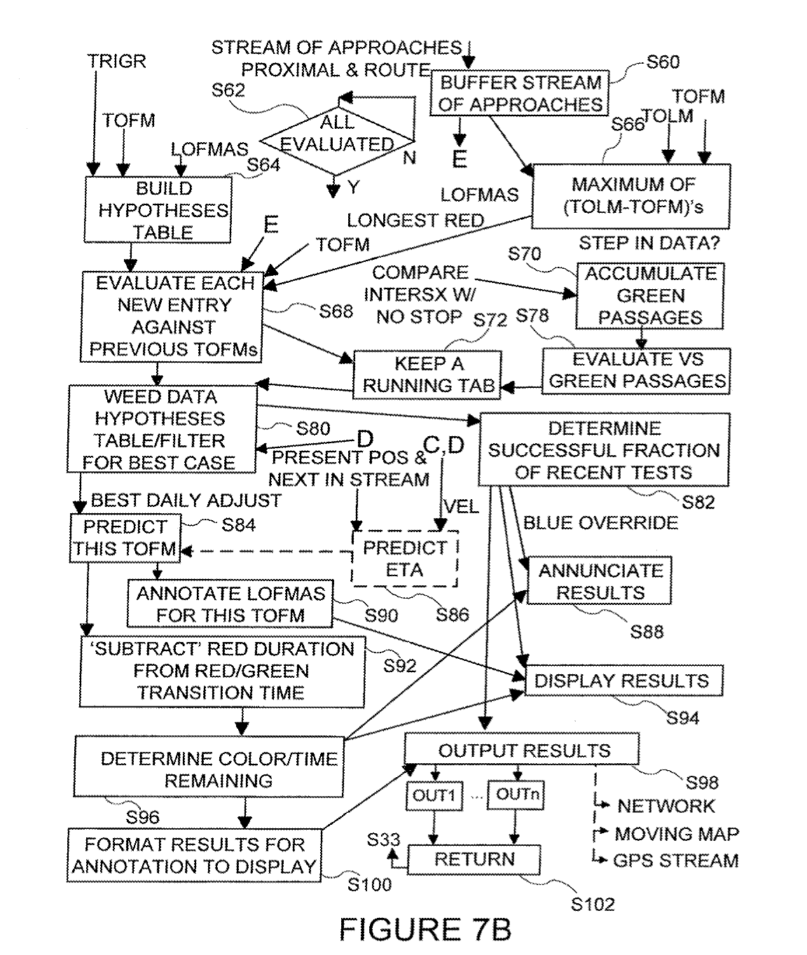

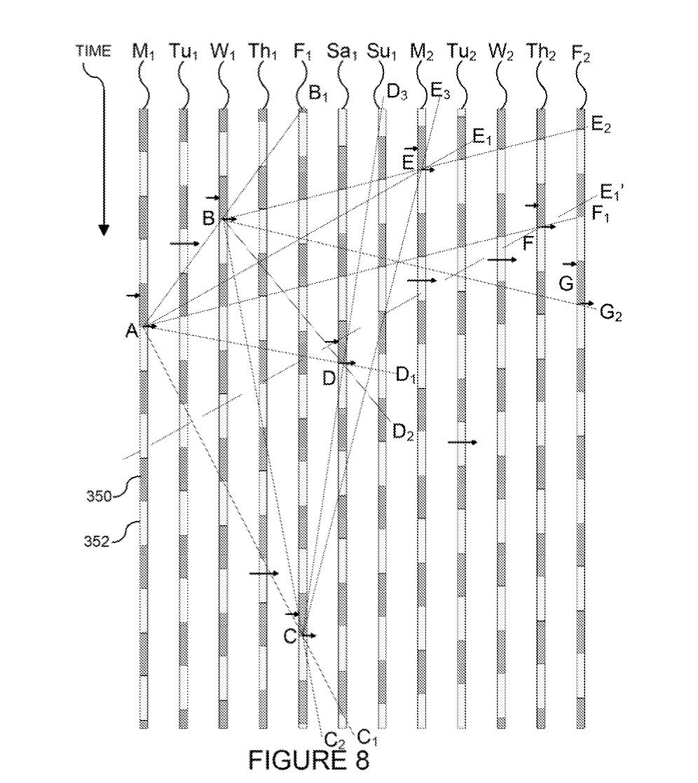

After removal of the vehicle power, V+, the first step of FIG. 9 detects the power loss, and initiates the shut down sequence. In our example, circuitry 510 is powered by the internal battery B1 (FIG. 9B) and uses random access memory, (RAM) memory 514 for memory storage needs of FIGS. 6, 7A, and 7B, for example step S33, or step S28.

In this example the RAM is easier to access and use, whilst the NVM doesn't require power during the interval that the unit is completely powered down.

Once data has been written to NVM, the unit completely shuts down.

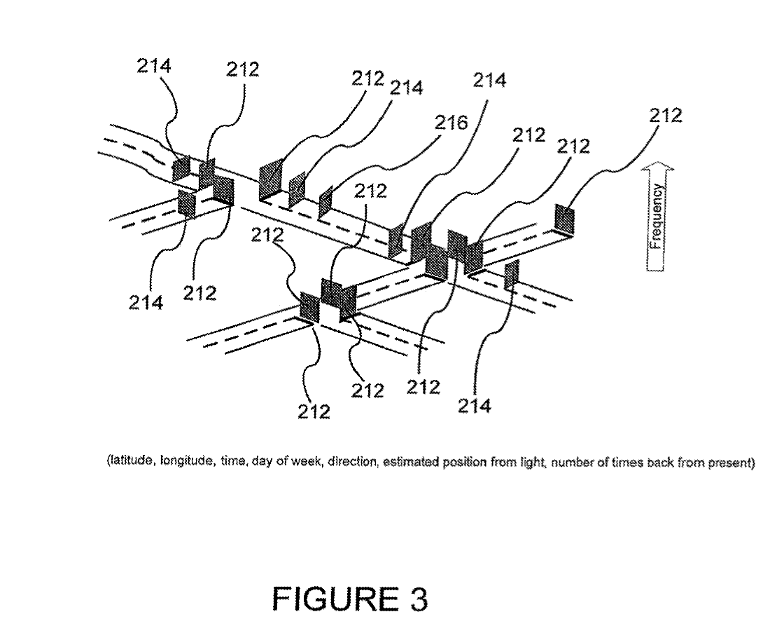

FIG. 3 shows a histogram developed from an exemplary database containing records of events where a carrier (vehicle) stopped at an intersection. In this context, a histogram is defined to mean a representation of a frequency distribution by means of rectangles with a bottom edge whose placement is a linear representation of a latitude/longitude combination. The height of these rectangles represent frequency of occurrence.

The histogram structure can be a three-dimensional array with an array of time of day, and day associated with the structure. The device of FIG. 1 can detect and store repetitive stopping locations using latitude/longitude and the time of stoppage for each of stops 212, 214 and 216. (The device of FIG. 1 can start with either present position, expected position, direction of travel, and compare it to the objects in the structure of FIG. 3.)

This example is for a very sparsely populated area with the vehicle stopping frequently at the various stop lines 212, that is, stopping at a traffic light without any intervening vehicles ahead. A moderate amount of the stopping events occur at (a) location 214, one car length back from the traffic signal, and (b) occasionally at location 216, two car lengths back. The heights of upright rectangles at locations 212, 214, and 216 are sized in proportion to the frequency of the stopping events. It is understood that other locations further back from the line can be used as well, optionally in conjunction with the aforementioned cases 212, 214, and 216.

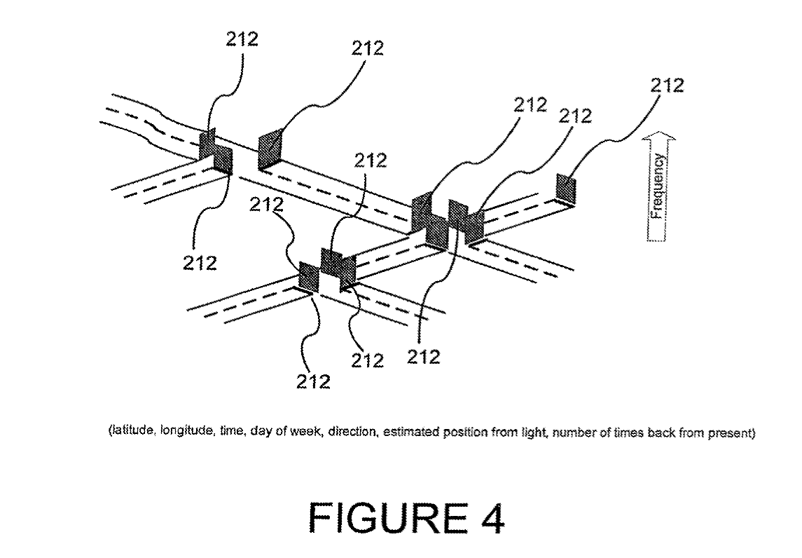

FIG. 4 shows a histogram filtered to leave only stoppages at the stop line.

Because vehicle lengths are different, the histograms for line locations 214, 214 of FIG. 3, are not as sharp as illustrated (i.e., they might appear more like a sloping ridge than a sharp plane or wall). Location 216 represents two vehicle lengths back and consequently will tend to be less sharp. For this reason less weight (a predetermined criteria for lowering the reliability rating) may be given to data associated with stop locations 214 and 216.

The data accumulated into this histogram includes the time of any stopping event in the close vicinity of a traffic light and then evaluates whether stopping events are closely related in time and space. If so related the processor 16 of FIG. 1 calculates the best estimate of the time and location for the stopping event for the purposes to be described hereinafter. In building this histogram, GPS offers both a highly accurate clock and re-synchronized if required, as well as, a somewhat refined indication of position. The system can use best guess information and makes the guess to the best of its capability, or using best information from a plurality of data sources.

Once a correlation is made, the set of accumulated data from previous stoppages at that location is ordered (i.e. last time, second last time, third last time etc.) and extrapolated, with the last entry being weighted the most. A prediction of when the traffic signal becomes a given condition (e.g. a green light) for this particular direction of travel, is developed by determining the experience from previous instances and deduces what the interval between the turnings green is.

As a simple example, for a given traffic light which turned green at 8:24:00 A.M. on Monday and again on Wednesday at 8:24:30 A.M., a prediction of when that light will turn green again Thursday will be 8:24:45. A subsequent measurement of the light turning green 8:25:45 A.M. on Thursday (but not the 8:24:45) suggests that the light may cycle on one minute intervals. Accordingly, with the foregoing data, then the set of predictions for Friday include 8:26:00 (8:25:45+15 sec), 8:27:00, 8:28:00, 8:29:00, 8:30:00, etc. Moreover, the light is predicted to be red for a certain number of seconds before each of those times in that given travel direction.

Lights are assumed to be pure signals (i.e. no arrows, or advanced or delayed greens) at first, but may be refined as the user uses manual controls to supplement event data, effectively teaching the device that the signal at this location has alternate paths, e.g. green at a different phase that permits left turns. Alternatively, the user teaches the system the exact position of a stop line as he/she passes it, or indicates anomalous activity and to ‘forget previous.’

Stops at some intersections will have been too infrequent to accurately predict future time of stoppage and one may need to wait for a build-up of stoppage data. Further data collection will permit corroboration and enhance the predictive powers of the system. If the said prediction is corroborated and reliable this fact can be displayed, annunciated, forwarded to a network or otherwise used. The absence of such a reliability rating suggests the unsuitability of such data and predictions. The reliability can be indicated by a non-standard color, such as blue in a graphical display. In some cases the level of reliability can be indicated by saturating a color or by increasing the volume of an audible announcement. In some cases, the exact time of turning green (i.e. present intersection) is removed a few seconds prior to prevent users from ‘running the light.’

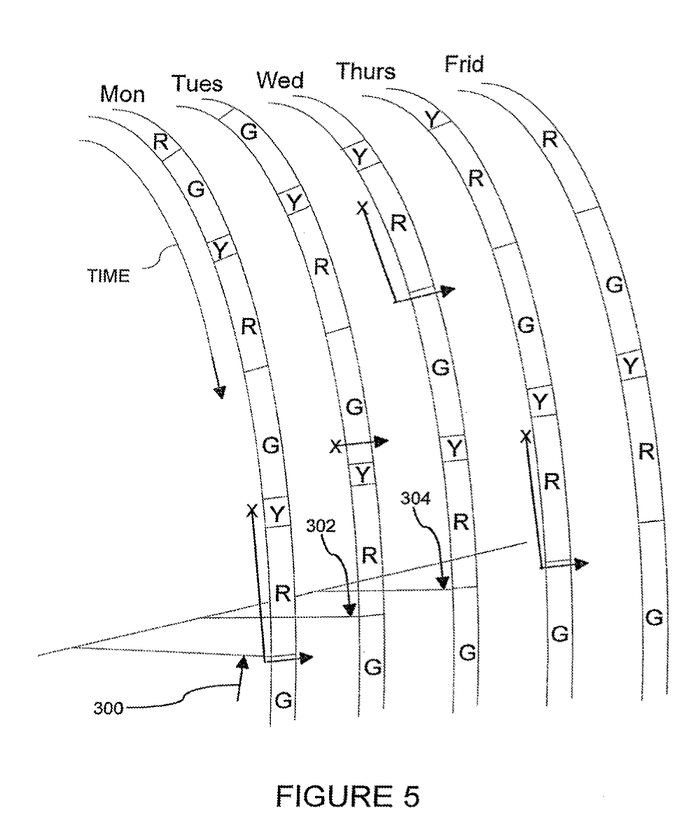

FIG. 5 represents traffic light sequences around the same time of day as five arcs representing five successive days (labeled as Monday, Tuesday, Wednesday, etc.). The representation shows the state times of a traffic light as a time-line position along the arcs. In the example, red lights are represented by R, green lights are represented by G, and yellow or amber lights are represented by Y. Arrivals at a given intersection are shown as ‘X’s followed by a line terminating in an arrowhead at the actual time of crossing.

For Monday the arrival marked X occurs at an amber light and is too late to allow immediate passage. The reference phase 300 indicates the occurrence of the next available red to green transition. For Tuesday the red to green transition occurring most closely to the same time of day is marked as reference phase 302. Note this phasing is not known a priori and may have yet to be determined. Similarly, the closest red to green transition on Wednesday is marked as reference 304. Again this phasing is not know a priori and may have to be determined. The day to day timing drift or phase from reference 300 to 302 to 304 can be a positive value, a negative value, or be very close to zero. The arcs can be filtered based on day of the week so that weekday vs. weekend meta information can be accumulated. The same is true for rush hour meta information. Meta information can be filtered based on reliability numbers previously discussed.

For example, the system may use the weekday information associated with a stoppage, accumulating information about stoppages at a given location. The stoppages may be filtered by location and then subsequently filtered by direction of arrival. In some cases the system filters by either the direction of arrival, or its opposite. The system need not use precisely the day of the week, but may instead filter the data looking for two in seven (i.e. weekend days vs. weekdays) to identify weak solution days.

FIG. 6 indicates a software process conducted by the previously mentioned microprocessor (processor 16 of FIG. 1) for compiling a database useful in the arrangement/method disclosed herein. Step S21, initial power-up, follows processor initiation, and downloads the database (previously stored in non-volatile memory 14 of FIG. 1) into random access memory (RAM) at step S22.

Step S24 makes accurate time available from the navigation sensor in the case of GPS, or optionally from conventional time keeping means, in order to provide switch SW3 with accurate time subdivided into small increments comparable to seconds; having time available in sub-second intervals provides better accuracy.

At step S23 the navigational sensor (sensor 12 of FIG. 1) continuously generates location updates in streaming form. These newest updates are also made available to switch SW2, which upon closure strobes background data into (volatile) memory at step S33, in a manner to be explained presently. These updates are sent by step S25 to a small buffer in order to store the last position.

Step S26 will then subtract this last stored position from the following (and yet to be buffered) update and in step S28 this difference will be stored in working memory.

This difference in position calculated at step S26 is an indicator for times when the position is changing and, conversely, an indicator of when the user is stopped. The resultant of subtraction step S26 yields non-zero values if the navigation sensor senses position changes substantially different from that previously retained at step S25. Step S26 supplies the direction of this motion to step S27 as an indicator of the direction of arrival, for purposes explicated hereinafter.

Upon a further iteration, step S26 calculates another distance difference and step S30 compares this new difference (signal A) to the previously calculated difference (signal B) that was stored earlier under step S28. If within a predetermined tolerance the new difference A is approximately zero and the previously stored difference B is not, step S30 outputs the affirmative conditional for this latest updating cycle, indicating that the vehicle has just stopped. Since the stoppage is declared within a predetermined tolerance, this stoppage condition is referred to as the carrier being substantially stationary.

The local clock may be an accurate self-contained timer for deducing the timing information. While the time standard of the GPS system may be used, in some embodiments a different clock may be used. It is noted in such cases the clock must remain accurate to within seconds within several weeks, although the clock is not necessarily synchronized.

In any event, step S30 strobes switch SW4 to store in the database of step S33 the stop time TOLM. Also, switch SW1 is strobed to likewise store DOA from step S26 in the database. Also, step S30 triggers step S32, which then stores in a buffer the stopping location obtained from output E of step S23.

The same information presented to step S30 (signals A and B) is presented to step S29. With step S29 if, within a predetermined tolerance, the previously stored difference B is approximately zero and the new difference A is not, step S29 provides an affirmative, indicating the vehicle is just beginning to move. Since the resumption of motion is declared within a predetermined tolerance, this resumption condition is referred to as the carrier ceasing to be substantially stationary Some navigational sensors, GPS, for example, can briefly continue to indicate slight vehicle movement after actually stopping (in relation to the earth) as the receiver processing refines the position slightly. This is a relatively slow process compared to that otherwise discussed here and false starts and stops can be rejected by comparison of succeeding updates.

A successful detection at step S29 of both a non-zero value from step S26 and a previous value of approximately zero from step S28 triggers at a point in time where the navigational sensor is just beginning to update once again after a stoppage. At such a trigger point the output of step S29 is presented directly to switches SW2, SW3 and optionally SW1 permitting background data from each to be made available for storage in step S33.

In response to the affirmative response OUT from conditional step S29, step S32 stores in a buffer the current time signal dispatched from step S24, which is derived from some remote or local clock or Umer.

As a result of the trigger output from step S29 and S30 the following background data can be concurrently stored at step S33:

(1) from switch SW1 carrier direction of arrival (DOA), triggered from either step S29 or S30, step S30 imposing a smaller load on processing;

(2) from switch SW2 approximate location of the first movement after stoppage (LOFMAS), triggered from step S29,

(3) from switch SW3, triggered from step S29: (a) time of the first movement after stoppage (TOFM), (b) time of day (TOD), (c) time of week (TOW), i.e., weekday or weekend, (d) time (i.e., day) of month (TOM), and (e) time of year (TOY), e.g., nth day of year or holiday.

(4) from switch SW4 time of last movement (TOLM), triggered from step S30, and from switches SW3 and SW4 time elapsed while stopped (i.e., TOFM−TOLM).

Storage of such data is herein referred to as storage of measured pairs (data from switches SW2 and SW3 or switches SW2 and SW4) and measured triples ((data from switches SW2, SW3, and SW4).

It is understood that these switches may be store and forward buffers to accommodate the streaming nature of the data flows.

The time elapsed while stopped is derivable from the difference between the values from switches SW3 and SW4, suitably adjusted by optional step S31a as will be explained presently. It will also be explained hereinafter that the elapsed time of stoppage of a vehicle will be used to predict the state of the traffic light at future opportunities and future predicted times of arrival at the traffic light.

Were predictions made presuming time information was collected right at the intersection stop line the prediction process might be oversimplified. Also, data collection insensitive to the time of collection might not consider, for example, that some traffic lights get re-adjusted after not so many hours or days. Better accuracy can be achieved by using more of the available information.

In cases where the vehicle is queued behind other stopped cars some distance from the nominal intersection stop line, one may want to adjust the times of stoppage of the vehicle for these backed up positions. For instance, a vehicle may not start moving soon after a traffic signal turns green until all the vehicles ahead have gotten their turn to move. Thus, using the navigational sensor output stream data optional step S31a permits filtering based on how far back from the perceived stop line the vehicle is (see FIGS. 3 and 4), and a consequent adjustment of the time that is passed by switch SW3, which adjustment is performed by altering the data just stored in the database of step S33 by switch SW3.

The foregoing adjustment depends less on the distance from the stop line and more on the number of intervening vehicles. The steps of FIG. 6 accumulate data about stopping locations and, as explained further hereinafter in connection with steps S34 and step S36, the system will identify whether that vehicle is at the forwardmost position recorded for this immediate vicinity, this forwardmost position being assumed to be coincident with the actual stop line.

Using the direction of arrival and the location association from the database [i.e. position sufficiently close to other(s)] the process deduces the farthest forward position and uses it with little or no weighting function washout.

Accordingly, the current stop location buffered in step S32 will be compared to the presumed stop line location and the difference will be divided in step S32 by a preprogrammed average length nominally occupied by a vehicle, to obtain an estimate of the number of vehicles between the vehicle and the stop line. Based on this, not necessarily whole, value an adjustment takes place using this number to alter the TOFM stored in the database of step S33 through switch SW3. Specifically, the times associated with the stop at this intersection will be adjusted to compensate for the delays associated by the intervening vehicles. The time adjustment calculated for in step S32 will be passed to adjustment step S31a, which performs the adjustment of TOFM by adjusting data in the databse. The start time sent through switch SW3 and in some cases the stop time sent through switch SW4 (or both) may be adjusted (start time advanced and stop time retarded).

In some embodiments, instead of simple time adjustment, filters may be used to weight the calculated stop times based on whether they are derived from locations determined to be spaced from the furthest forward position or stop line (taking into account the location output from step S23, and earlier data retrieved from step S33) and weighting remote positions less than ones that are calculated to be closer to or at the stop line, i.e. giving more credence to the values obtained at the stop line over values that have used the distance from the stop line as part of the calculation.

Additionally, many different filters can be applied in step S31, including filters relying on user supplied information 400 (step S31 of FIG. 6) that creates manually inserted tags OUT2, such as a tag that the current stop is being controlled by a right turn arrow, a left turn arrow, a flashing light, or other lane options (such as driving straight through, but waiting for a light to change from a turn arrow before proceeding, etc.). Another such optional input 400 is an ‘on highway’ indication which temporarily disables data collection; assuming the highway has no traffic lights.

Examples of other filters include either rejecting all time and location values that occur at less than the furthest forward position, which is assumed to be at the stop line (intersection).

A further variation on this is to analyze the stored data of all known stoppage locations against the present stoppage location and do a statistical analysis of such data, such as a least squares fit, and then determine if there are any time shifts, indicative of a re-synchronization of the traffic light. The output of such a calculation will then be used to segregate data relative to the resynchronization. Accordingly, the weighting factors for data prior to any such detected time re-synchronization will shift to zero so that they do not degrade the data. Meta information may be calculated to permit filtering of such items as resynchronization of a neighborhood, for example.

In conjunction with the background data stored at step S33, the filters of step S31 of FIG. 6, can optionally further reject mandatory stops (based on frequency—if one always stops here and its for less than a certain number of seconds, this is interpreted as a stop sign), stops at yield signs (if the user sometimes stops, always slows down, and sometimes stops for a seemingly random period of time this is interpreted as a yield sign), stops for traffic congestion (something of a random nature), or traffic that is stopped to discharge or pickup passengers. Data being collected can either replace older data (in a fully populated database) or label the data type in an actively-collecting data base.

Any of these filters can be applied in any combination without deviating from the teachings of the present disclosure. Also, while data collection is stored and qualified based on when navigational information changes, equivalent data can be obtained by collecting data based on a lack of a change in navigational information, e.g., times of motion as opposed to times of stoppage can be used for calculations and so on.

Several parallel threads are being executed in FIG. 6. The thread(s) associated with steps S29 and S30 was just explained. Another thread that is being executed concurrently is one that determines velocity at step S27 by processing the direction of arrival data stream determined from step S26. The continuous stream of differences between the last position and the previous, containing both the direction of arrival information and the magnitude of the difference, is passed to step S27 where by dividing the distance increment by the difference in time, a continuous stream of velocity is provided at output C.

Referring to FIG. 7A, previously mentioned step S33 is reproduced for convenience. FIG. 7A shows, among other things, the control flow representing the processing of the data executed to reduce the data into classes based on proximity in order to get approximate stoppage locations associated with a traffic light and common directions of arrival thereto.

Step S34 upon receiving on an input from step 29 OUT, the trigger signal from step S29 (or a trigger from step S31, both in FIG. 6) retrieves the LOFMAS data most recently stored (or being stored) in step S33. The system compares this most recent location data to other LOFMAS location data stored in the database of step S33. The step determines the straight-line distance from the most recent data to that previously stored in the database. If the recent data can be grouped with other data which fall within a spread that would be considered a reasonable range of locations that a vehicle could come to rest at a single stoplight, then step S34 lumps this latest data into the data set of all values that correspond to this location. The carrier (i.e., vehicle) locations of this grouping are considered spatially correlated and equivalent for purposes of this specification. The grouping can be based on simple proximity criteria or can be more elaborate and include locations that are within a given number of car lengths from a forwardmost stopping location, and optionally adjusted to account for that displacement. This data set is referenced in the database by a unique location identifier and is referred to as a Known Intersection (KI).

Step S36 stores the actual location for this intersection and holds it for one iteration cycle. Thus on a succeeding cycle step S36 makes available, what has now become the location of the previous intersection relative to a new or next intersection. This prior location is appended to the latest entry in the database as a prior location attribute (PLA). Consequently with the linking of the prior location each time a new LOFMAS is stored, the database entries now have a previous location available as part of the data set for a given intersection, including the one that the user is at presently.

In a manner similar to step S34, step S37 now searches the database of step S33, but now looks out at some predetermined distance for locations (LOFMAS) that are not likely associated with the most recent stop. The distances sought cover a much larger range, e.g., several city blocks or so many road lengths in a rural setting. Each LOFMAS qualified by step S37 produces a stream of locations constituting proximal intersections, which are candidates for being an upcoming intersection the driver may want to traverse. Step S37 supplies this stream of potential intersections to step S40 which uses this as vicinity information.

Upon occurrence of start trigger output OUT (from step S29 of FIG. 6) step S35 receives the present position supplied to it from the output of step S23 (also FIG. 6). Using this present position, step S35 probes the database to find data sets whose prior location attribute (PLA appended by a step S36 operation) matches this present location value within a predetermined tolerance. Step S35 outputs as a data stream to step S38 the corresponding LOFMAS, i.e., the locations found linked to the present location. These are likely locations that the user is headed to. This data is labeled the UPCOMING INTERSECTION data stream.

The UPCOMING INTERSECTION data stream from step S35 is sent to step S38, which will try to find succeeding links, so that the first round of links can be linked in turn to other links, and so forth. Step S35 checks the database for any LOFMAS that may have been tagged with a prior location attribute (PLA) that matches items in the UPCOMING INTERSECTION data stream. Any LOFMAS found and thus linked to items in the UPCOMING INTERSECTION data stream can in turn be linked to another LOFMAS in the database by using the same method (finding another LOFMAS whose PLA matches a LOFMAS already included in the set being assembled).

This process produces a number of linked locations or intersections that can be considered legs of previously traveled routes. In some cases routes may have a common initial path, but then split into two or more branches, where some branches may in turn split into multiple sub-branches. As will presently be explained, using anticipated light phases, the system can estimate the travel time for various legs of a journey, and can even suggest alternative routes that may have a shorter calculated travel time. A prediction of stoppage delays at such intersections may be lumped in with other time to obtain travel information for legs of a journey (where many non-synchronized intersections will likely waste time especially during rush hour).

The process produces new locations that are added to the UPCOMING INTERSECTION DATA. The process repeats until no known potential locations remain. For practical reasons the system will have a user selectable limit on the number of links that can appear in any route. Optionally, the distance of proximal intersections evaluated is user adjustable.

Optionally the frequency of each LOFMAS in the stream can be counted and tagged with a parameter as a predetermined criteria that provides a reliability rating based on prevalence in the database. This prevalence tag can be ultimately used to indicate the likelihood of a particular route in a user interface such as a moving map environment. The more likely routes can be shown as a more saturated color. The number of potential routing options can be user limited to the most popular, or to just proximal ones.

Using velocity calculated at step S27 (FIG. 6), user selectable (or system measured) values for accelerations, average velocity, deceleration for each link (intersection to intersection) in a route can be used to estimate the time to travel for each link. The velocity from step S27 includes the direction; and in some embodiments continuation of location updates can be obtained from step S27′, which uses a transducer to sense the direction and turning of the steering wheel.

An alternate method of determining estimated time of arrival (ETA) is to use the direction of arrival (output of step S26 of FIG. 6) and the present position (output of step S23 of FIG. 6). Based on the street distances derived from the locations of known intersections, and suitably modifying them by anticipated accelerations, the arrival time at the next intersection can be estimated.

These ETAs are appended to the UPCOMING INTERSECTION data stream at step S38.

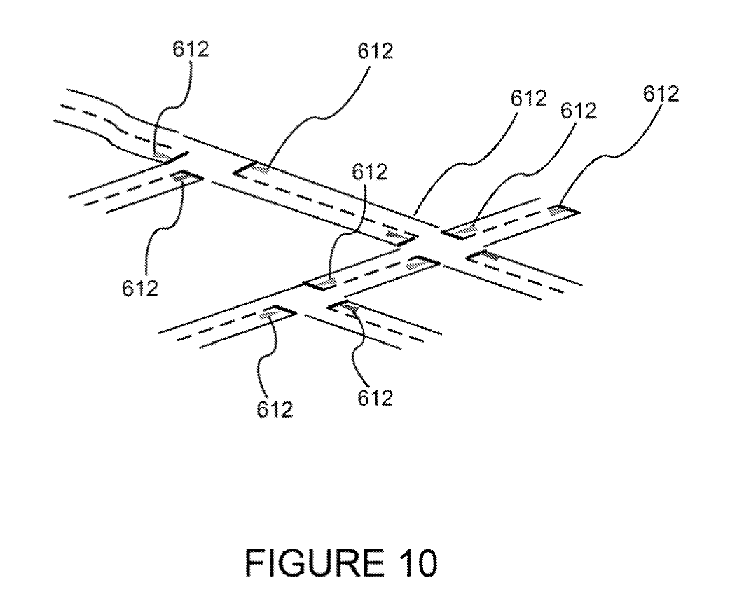

If ultimately a map is used to display a route, the routes can be annotated on the map along each link. At each intersection, i.e. LOFMAS, this can be used to show estimated time of arrival (ETA) for upcoming intersections. See FIGS. 10-13.

Using the UPCOMING INTERSECTIONS data stream and vicinity intersection data supplied from steps S38 and S37, respectively, step S40 assembles the corresponding location information from the database (of step 33). Data extracted arrives with the (raw) direction of arrival parameter, the time of first motion (TOFM) parameter, and these are correlated with the ETA derived during step S38 for all of the anticipated intersections.

Step S39 normalizes the location stream from step S26 to deduce the direction of arrival that the vehicle is presently executing and rejects data points with directions of arrival that are not sufficiently similar. Step S39 strips off data from non-similar directions of arrival (DOA's) retaining only data with similar directions of arrival. Optionally the system can use time information concerning approaches from the opposite or intersecting (transverse) direction(s), i.e. times from inconsistent directions can bolster younger databases until sufficient data is accumulated from a consistent direction, i.e., approach. As the various intersections will have different amounts of information stored, some of the data points i.e. LOFMAS data, will need this bolstered data to perform predictions described thus far and hereinafter.

Reviewing the foregoing, each time that a stop occurs, a new data point is stored at step S33, along with a previous location attribute (PLA per step S36), etc. The storage of this information acts as a trigger for adding this update to the appropriate equivalent data set (i.e., equivalent carrier locations correlated as being within a short distance, in other words at the same intersection). The bulk of the processing shown in FIG. 7A was concerned with the preliminary work of identifying the upcoming intersections to allow the system to make estimates of traffic light phase for these upcoming intersections. Accordingly, the regularly updated data sets can be summoned as a group and analyzed in what is herein referred to as a hypothesis table.

Referring to FIG. 7B, this chart represents the processing of the final extraction of the times, the weeding of the database, resolution of whether the output has fidelity, and the preprocessing for communication to the user.

Step S60 buffers the incoming stream from step S39 of FIG. 7A of proximal and likely upcoming intersections with appropriate DOAs. Hypothesis tables are constructed and updated for an upcoming intersection at step S64, which receives data points one at a time from step S60. Step S64 constructs a table of hypotheses concerning the particular intersection under consideration. The table consists of the times and locations from the data stored at step S33. At step S68 new data points from the most recent stop/start are evaluated against earlier data for the particular intersection in a manner to be described presently.

While all of the foregoing concerned data collected from stopping at an intersection, free or green passages through known intersections (suggesting a traffic light was green at the time of arrival and passage), are also stored at step S70. At succeeding step S78 these green passages are evaluated against the earlier data in a manner to be described presently. Certain green transitions rule out certain hypotheses that might be used for data set matching. These cases are weeded from the hypotheses table at step S80.

Referring to FIG. 8, the background information is that of a scenario in which information about the traffic light phases is incomplete and the system will attempt to resolve the unknown factors. Comparing this diagram to FIG. 5 may be of assistance for this discussion. For clarity only the edges of each of the time slices are shown.

The data gathering function based on random or pseudo random times of occurrence will result in very different scenarios. This particular scenario is presented as a typical example. Shown across the top of the diagram are the days of the week, for example M1 indicates the first Monday. Tu2 indicates the second Tuesday and so on.

Item 350 is a shaded area representing the underlying combined yellow/red phase of the traffic light being analyzed. Item 352, a non-shaded area, indicates the green phase of the traffic light being analyzed. Note: the system cannot yet identify this phase information. The following explanation will show that the underlying phase and duration of the colour cycle can be deduced given enough information extracted from suitably random attempts at crossing the same intersection, which in the extended case could be days apart.

For the exemplary case, the user arrives at the intersection within a window of approximately one half an hour in length, such as the user might experience in going to work in the morning. The case further happens to be one wherein the user waits at the light for other than a right turn on red (a case that the system doesn't provide suggestions for).

The analysis of the information begins once enough attempts to cross the intersection have been made.

### Extraction of the Red Time

Many different ways of extracting the red/green transition time can be made. This one is an example but any such method is considered within the scope of this disclosure. For each new value added to the data base at step S33 in FIGS. 6 and 7A, step S66 of FIG. 7B, being constantly revisited, checks the time stopped at an intersection by subtracting the TOFM from the TOLM which were stored in the database at previously mentioned step S33. This calculated stop time is compared to previous experience at this intersection to determine the maximum stop time, rejecting any values that seem extreme or inconsistent with the bulk of the data. The maximum thus determined should approach the actual time that a traffic signal is red.

To calculate the start of this “red time” the maximum from step S66 is deducted from the hypothetical lines for each of the possible proximal intersection transition times. [To be clear, the red times are actually composed of the combined red preceded with a fraction of the yellow times if applicable. The red time to be derived here is actually either the fraction of the red time that can be deduced or that time which includes the fraction of the yellow time that the user could be stopped before. i.e. this device, in this example, does not differentiate between the red times and the combined yellow and red times.]

Processing of the information begins once the resultant of the calculation at step S66, FIG. 7B is sufficiently reliable. The maximum value ascertained by calculating stop time for approximately 20 stops is sufficient, or once an individual sample is determined to exceed 20 seconds. This is referred to as the “red time” or maximum duration. The value calculated at step S66 continues to be refined with each stoppage unless removed by the filtering of step S31.

Without deviating from the present disclosure the value of the red time can be further refined, with operator manual input indicating the exact time of intersection passage, the exact time of a green light occurring, even sensor information indicating that the light has turned green is within the present disclosure. For example a driver can use the keyboard of FIG. 2 to signal that a light has just turned green and this observation can be used to refine time data that is being contemporaneously stored in step S33. Other user operable devices are contemplated, where the system can be trained by voice commands or a combination of voice and the timing of movement (this latter being the usual method of training) wherein the voice input is from the user. A small set of words green, red, or yellow can be used to describe the light state, even from the second or third position while waiting at the lights to more finely resolve the time of the light switching states, before adding the data to the database for further processing.

This user input can indicate more than whether a traffic signal has changed state. The user can indicate whether the vehicle is departing under the guidance of a left (or right) turn signal; or whether the departure is under the guidance of a signal permitting non-turning departure.

In other embodiments, a camera can automatically supply this timing information by graphically detecting the point in time that the signal light changes state. In still other embodiments, timing information can be detected in advance from a telemetry-like link originating from the infrastructure, i.e., from the governmental or private agency responsible for the relevant streets, highways or transportation.

As described below the red time is useful in reducing conflicting interpretations of the data when making predictions of traffic light activity. Collecting information about when a vehicle stops and restarts is illuminating because this time data represents an exact phase state for a traffic light under consideration. Moreover, every prediction of red to green transition is presumed to be preceded by an interval representing the red time, and this presumed red interval might be contradicted by new data showing a green passage or a red to green transition (i.e. the TOFM cannot occur in the middle of a “red time.”)

The green passages collected in step S70 of FIG. 7B is useful because green transitions can be analyzed together with events where the vehicle stops. As an example of a contradiction, consider the ‘red zone’ that should precede line B1 running between points B and A in FIG. 8. When line B1 is tried against the events of the first Tues Tu1, the green passage that took place then would be taking place during a red light, if line B1 is deemed an accurate representation of the progression of red to green transitions from day to day. Consequently the line B1 is contradicted and ought to be removed from consideration, i.e. the entry BA is eliminated as a predictive tool.

### Hypotheses Tables

At step S64, a hypotheses table is constructed in memory. For the earliest element in the table, essentially the TOFM for point A, FIG. 8 shows an attempt to cross the given intersection prior to the TOFM, that is, at a time when the traffic signal is still red. Thus, the driver must remain at the intersection until time A. As this information is collected it is stored in the database for later use in a hypothesis table.

The next data point on the first Tuesday Tu1 is a crossing on what happened to be a green light, and is stored in memory as a green passage. The next attempt to cross the same intersection (on the first Wednesday, W1) is met with a red light and again some waiting time is involved. The user waits until time B.

Again the B crossing event is available for use in a hypotheses table (step S64 FIG. 7B). Correlated with the B entry is the amount of time that the B crossing event is advanced/retarded from the time of the A crossing event, normalized to a per day value. In this case two days passed, and B was determined to have occurred, say, 46 seconds earlier than on Monday. This difference was recorded as a daily shift of minus 23 seconds per day adjacent to the entry for B. This is represented in FIG. 8 as the line labeled B1.

A subsequent undeterred attempt to cross the intersection was made on the first Thursday Th1, at what happened to be a few minutes later in the morning, and happened to be a green light. This event is stored with the other green passage previously mentioned for Tuesday Tu1, at step S70 of FIG. 7B.

A subsequent attempt on the first Friday F1 when the same light happened to be red is indicated by event C, with the time of arrival TOLM and the time of departure TOFM each being marked with an arrow. Two entries are made in the hypotheses table adjacent C. The first entry is that of the hypothesis that can be made relative to the time data event B, which by subtraction of the TOFM for event B from the TOFM for event C is calculated to be, say, 7 minutes and 21 seconds later (in our example). At step S64, the first of the two C entries is labeled CB. Adjacent the entry CB (line C2) a corresponding entry is made for the value of 441 seconds/two days, normalized to a daily shift value of +220.5.

For the CA entry (line C1) the difference in the TOFM for events C and A is 6 minutes and 30 second (390 seconds), and therefore a corresponding entry is made for 390 seconds/4 days, i.e. a normalized daily shift value of +97.5 seconds per day. While this last value is acceptable, with the scenario of FIG. 8 further processing will not likely yield enough sufficiently similar shift values to corroborate this particular daily change.

In our example the next time that the user attempts to cross this intersection in the same direction is on Saturday Sa1 and occurs slightly before the red to green transition and so the vehicle must again wait to cross. At step S64 (FIG. 7B), three values are entered in the hypotheses table for DC, DB, and DA (lines D3, D2, and D1 (FIG. 8)). These entries represent the deductions that can be made from straight line assessments of the differences in the TOFMs from (1) D with respect to C, (2) from D with respect to B, and (3) from D with respect to A, respectively, all from FIG. 8.

For the D3 entry, the time of attempted crossing happens to be 6 minutes and 6 seconds (366 seconds) earlier than C, which happens to be the previous morning. In keeping with the foregoing convention, a daily shift value of −366 is entered in correspondence with the DC entry. The other entry D2 (that of D with respect to B (FIG. 8)) yields a daily shift of +70 and is associated with the DC entry. For the remaining D1 entry, the subtraction of the TOFMs for events A and D yields 24 seconds causing a daily shift of +24 to be entered in the hypotheses table adjacent DA.

Similarly for crossing event E a number of projected daily shifts can be calculated. Three of the four being shown as lines E1, E2, and E3.

Although at first glance the number of projections of daily shift appears to grow rapidly per each new TOFM entry, the incremental rate is based on the number of TOFMs that are useable. A number of approximately 20 or 30 useable TOFMs is sufficient for almost all calculations, although the exact number depends on the degree of randomness that the user has in arrival times at the same intersection, in the same direction.

Assume now that another intersection crossing occurs on the second Thursday Th2, which is marked in FIG. 8 as crossing event F. As before, event F will be projected back to each of the prior of events A-E to calculate a normalized daily shift value for each. One such daily shift value is obtained from the projection between events F and A, and is shown as projection line F1.

The foregoing algorithm assembled values for normalized shifts. The following algorithm will derive from the background data of step S33 one or more predicted future events. Specifically, the following algorithm will give a predicted time around which a traffic signal will change state for a location where a carrier or vehicle previously experienced a stopping incident (e.g., a carrier location where a carrier ceased being substantially stationary or became substantially stationary).

### TOCD Calculation

The Time of Cycle Duration (TOCD) may now be algorithmically derived as part of step S68 using background data that correlates to a given intersection (i.e., data correlated to equivalent carrier locations). The daily shift value determined above is projected back; e.g., transition predictions are placed along projection line F1. Then, the F1 prediction is compared to the measured TOFM for the day of the next stoppage; here the first Wednesday W1. For our example the daily shift is found to be say negative 6 seconds per day. This corresponds to a red to green prediction on Wednesday W1 that is 12 seconds earlier than event A on Monday M1. Calculating then the difference between this prediction and the measured TOFM for event B on Wednesday W1, a difference of say 34 seconds is found. Since one cannot be sure how many cycles are contained in this 34 seconds, this 34 second difference is set equal to a multiple of the TOCD; i.e., equal to n X TOCD. If one knew all the information that is revealed in FIG. 8, one could immediately declare that n=1, however, in general this time difference can be large and the number of cycles encompassed will be uncertain. The TOCD information will be bounded by the lower limit of the maximum red time (maximum duration) calculated in step S66 of FIG. 7B.

For the daily shift, and the TOCD, a calculation of the confidence is made. This is done by using the results of the TOFM from the next four or five attempts to cross the intersection and trying them against the anticipated values. This establishes a predetermined criteria such that the closer the value is to being correct the higher the confidence value or reliability rating.

In this embodiment the system calculates all the time differences (corrected for daily shift) among the TOFMs. Specifically, the m events (e.g. events A-F) will be paired to produce m(m−1)/2 differences. Before calculating the difference between these time pairs, all these events can be referred to a standard day, typically the day the calculation is made. For some pairs, such as events B and E, their difference will be zero and will be discarded. Taking the difference between times that are referred to a standard day is, in effect, the same as subtracting the uncorrected time values and dividing the difference by the greatest integer that produces a factor with a magnitude less than twenty four hours. Both techniques are equivalent mathematically and both are considered a way of normalizing the time differences. For this reason the result obtained from these two techniques is referred to as normalized shift.

The system assumes the time differences (normalized shifts) will satisfy some periodic pattern associated with a cycle time TOCD. Since the resulting time differences should be a multiple of the TOCD, the system will first assume that the lowest value (a postulated cycle time) is the actual value of the TOCD and check whether all the other differences can be characterized as multiples of this smallest value. Checking is complete if all the differences match this pattern (with perhaps a small number being ignored as erroneous artifacts). If not, the system will assume this smallest value is twice the actual value of the TOCD (i.e., postulate as twice the cycle time) and again check whether all the other differences can be characterized as multiples of this assumed value of the TOCD. If the differences of do not satisfy the pattern, the process can be repeated with the smallest value being characterized as a successively greater multiple of the TOCD until a reasonable data match is obtained to arrive at a best estimate of TOCD (i.e., a usable postulated cycle time).

### Weeding

Taking the most recent event, event F, the system can now apply to this event the normalized daily shift values derived from earlier projections (projections obtained without using event F). Specifically, in step S80 the system will use the TOFM for event F as a test time to test the consistency of the other projected daily shift values, i.e. the values associated with lines A₁ through E₃ (line E₄, constituting the projection between events E and D, is not illustrated, but can be tested as well).

As an example, the daily shift associated with projection line E₁ can be applied to event F. This analysis is shown graphically in FIG. 8 as running a line E₁′ parallel to projection line E₁ through the red to green transition of event F. This projection from event F is mathematically equivalent to arithmetically combining the test time for event F and an integer multiple of the normalized daily shift to determine a normalized time at another day. It will be noticed that projection line E₁′ intersects the timeline of first Saturday Sa₁ just prior to the red to green transition for crossing event D. The TOFM of event D will be considered another test time paired with the test time of event F. Note these two test times and projection line E₁′ all correlate to the same intersection (carrier location). In this case, the projection line E₁′ intersects the first Saturday Sa₁ timeline before the red to green transition by a time interval that is much less than the “red time” (maximum duration) calculated by step S66. Thus, the daily shift value of line E₁ implies one should have been able to freely travel through the given intersection at that time on day Sa₁ even though the data of event D is contradictory and shows the traffic light would have been red at this time.

Since the daily shift value of line E₁ when projected from event F is inconsistent with the data of crossing event D, the system notes that this daily shift value has flaws, i.e., has failed one test against measured data. The system will therefore annotate the daily shift value of projection E₁, keeping a running total of the number of failures to develop a consistency rate.

Also, projection line E₁′ intersects second Monday M₂ just after the illustrated green passage. Passage information that originated in step S70 is passed along by step S78 to step S72, which in turn passes green passage information to step S80. Step S80 calculates the red to green transition predicted by line E1′ for Monday M2 to find this transition implies a preceding red interval (from step S66) that would overlap this green passage. Thus, the daily shift value of line E₁ when projected from event F is inconsistent with the green passage data and the system will again annotate the daily shift value of projection E₁, adding to its running total of failures.

The system will give less weight or will declare invalid and discard daily shift values that have failures.

If the daily shift value associated with projection line E₂ is applied to event F, one would again run a line parallel to line E₂ through the red to green transition of event F, but this line would match line F₁. It will be noticed that only one data point is then intercepted, namely, crossing event A. In this case, the red to green transition of event A is consistent with projection line E2 when applied to event F. In effect, the TOFMs of events A and F are separated by an integer multiple of the normalized daily shift associated with line E₂. and all correlate to the same intersection (carrier location). In some embodiments nothing further is done, but in this embodiment the daily shift value associated with projection line E2 will be annotated with the fact that this value was found consistent with subsequent data in order to refine its consistency rating. The system will give a greater weight or a preference to daily shift values that have been validated in this way, weight increasing with the number of validations.

In this case the daily shift values associated with projection lines E₂ and F₁ are the same, within some predetermined tolerance. In response, the system will consider them the same and will no longer need to run separate projections for each. When projection lines are combined in this way the resulting common daily shift value will be annotated with this fact and also with a running total of the number of times this daily shift value was independently corroborated so that projection lines could be combined and treated as one. The system will give a greater weight or a preference to daily shift values that have been corroborated, weight increasing with the number of corroborations.

Some of the hypothetical projection lines of FIG. 8 will intersect (be non-parallel with) the lines E₂ and F₁, which represent the front of times of constant phase. For lines crossing this front the number of correct solutions is weak. For example for lines line D₃ and E₃ failures occur in a relatively high proportion to any that “work out.” For lines that are along the front of constant phase, such as E₂ and F₁ failure will be less likely. In larger data sets the disparity in failure rates will become abundantly clear. If the figure of merit parameter is sufficiently low the line entry is removed from the table based on red/green transitions, although for some embodiments a single failure will constitute grounds for removal.

As the table becomes filled and as many more cases are tried against the hypothetical lines and lines are eliminated from the database, convergence will occur and only a few predominant lines will remain, such as indicated by E₂ and F₁, and perhaps ones like C₁, depending on the times of the attempts to cross the intersection. When lines like lines F₁ and C₁ survive, preference will be given to the one with the lower daily shift value, that is, line F₁.

The hypothetical line with the highest figure of merit is the one that is used for future calculations. The daily shift parameter that is associated with this hypothetical line that is used in this calculation is the number of seconds that the phase advances/retards per day.

Many different methods of calculation of the exact or approximate time of phase are also considered to be in the present disclosure without deviation. For example, processor 16 may simply try successive values for the cycle time TOCD, iteratively changing the postulated cycle time in fine increments over a presumed range of possible cycle times (e.g. 20 to 600 seconds) in order to find one or more postulated cycle times that provide a good match for the measured red to green transitions TOFM for a given intersection. Basically the system tries to fit the data for equivalent carrier locations into a periodic pattern. Once a postulated cycle time is algorithmically confirmed by the background data, one can extrapolate successive cycle times to arrive at a predicted future event; namely, a red to green transition for a traffic signal.

### Output the Results

Traffic lights lacking sufficient predictive data, or erratic lights that have changing repetition rates or lose synchronization, meet a predetermined criteria such that the reliability rating remains below a threshold value. Intersections with reliability ratings below this threshold are identified as such in the displays described herein, or optionally with a corresponding sound, perhaps when optionally touched or requested of the hardware.

Step S84 is supplied with the ETA for the traffic light from step S86, as well as, step S36 (FIG. 7A). Step S86 predicts ETA for the locations E presented by step S60 by using current and expected locations and the velocity data C (from step S27 of FIG. 6) or as presented by the KI and proximal intersection stream from S39 of FIG. 7A. Step S84 extrapolates the phase of the traffic light of interest proximal to ETA and compares it to the ETA supplied from steps S39 and S36.

For example, predicted future events may be algorithmically derived for the second Friday F2. Since a daily shift value and cycle time (TOCD) are known with some level of confidence, useful predictions can be made from event F. While predictions can be projected from any other event, events closest in time tend to be more reliable. If the daily shift value is Td and event F has a red to green transition (TOFM) of t1, this predicts another red to green transition tomorrow at approximately (t1+Td). If the TOCD is Tc, this leads to a predictions of other red to green transitions tomorrow at a set of times, namely: ((t1+Td)+n Tc), or even t1+n Tc; where n is an integer (zero, positive and negative whole numbers). On the mth day following event F the prediction will be about ((t1+m Td)+n Tc) or again t1+n Tc where n is an integer.

The foregoing process can be used to predict the time of red to green transitions for any of the intersections that are present in the buffer of step S60. The system will simply select the red to green transition immediately following (or with adjustments, preceding) the time under consideration, which may be the current time or the time of an ETA. If the time under consideration precedes the predicted time transition by less than the red time obtained by step S66, the system declares a red light, otherwise a green light is declared. This evaluation is performed in step S92.

The above calculations are repeated for each of the intersections in the data stream of proximal and anticipated intersections.

These predictions of traffic light phase are then presented to steps Annunciate (S88), Display (S94), OUTPUT RESULTS (S98) for use by: users of the Internet, a network, vehicle occupants, users, other vehicle, transit system electronics, or combinations thereof. The outputs of steps S88, S94, and S98 are provided with information from steps S82, S90, S96 and S100.

At step S94 the results are displayed graphically. The display receives from step S96, the amount of time remaining on a given traffic light. The time remaining before a red to green transition is derived from data provided by step S92 for each relevant intersection. This can be indicated on a moving map display, which also receives input from a navigation system such as the cell network, a data network, a GPS, a GPS DVD, or some combination thereof. Ancillary information is made available to the system via the traffic infrastructure (links for agency in charge of maintaining the transportation system), the Internet, a cell network, satellite pictures, on-coming traffic optical links, or otherwise. Also, data may be collected in some plurality of vehicles and transferred to for use by other vehicles, qualifying the type of data to be transferred, preprocessing it in some cases. This aspect of information transfer can be performed real-time, or by storage to a common data base or a combination of each.

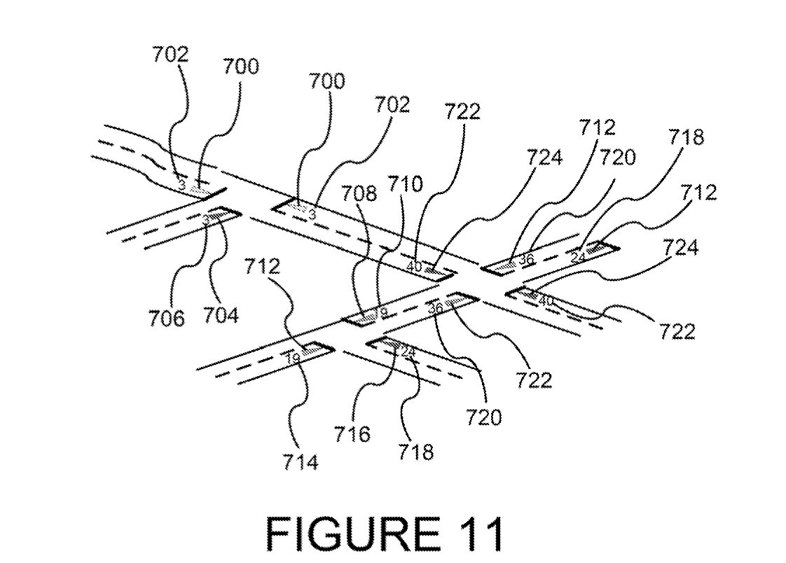

In one embodiment of the present disclosure the time remaining information for the phase of a particular traffic light is indicated in step S94 as a number or icon having a color that corresponds to the phase of the traffic light. In yet another embodiment of the present disclosure the time remaining for the phase of the traffic light at the ETA for that given intersection is annotated in step S94 on a map for that intersection in the color appropriate to the phase that the traffic light will be for the ETA. See FIGS. 10 and 11.

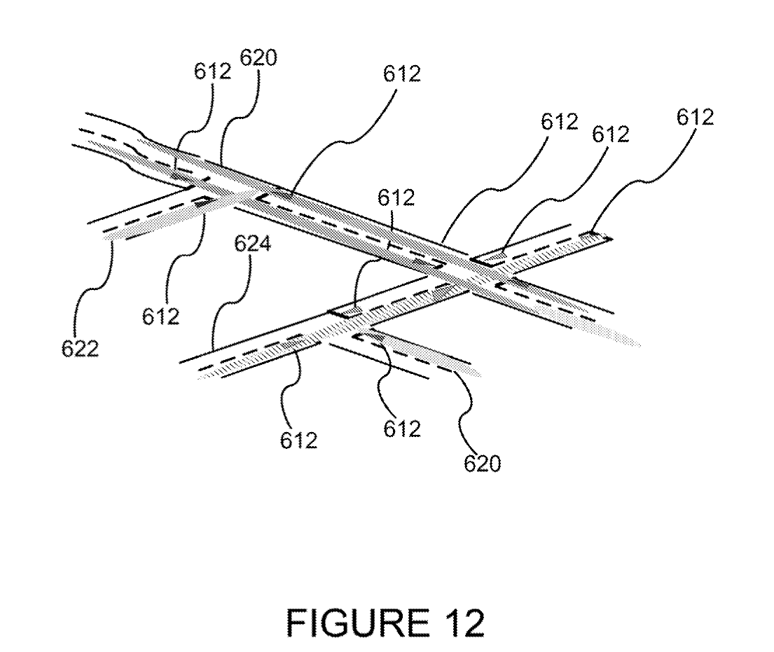

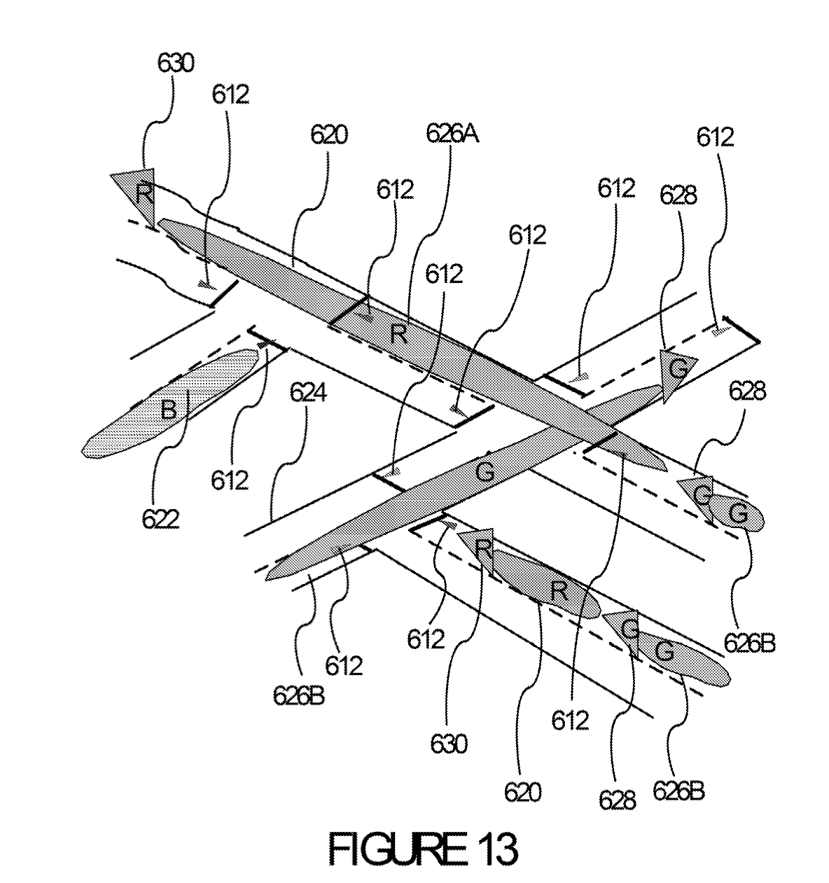

In yet another embodiment of the present disclosure zones that indicate the appropriate condition that a user might anticipate in a given area are annotated on the display, or formatted in similar fashion for external on-board, or network use. See FIGS. 12 and 13.

Step S98 formats and outputs the results for use by other vehicles or internet systems, such as traffic flow control systems, or bus scheduling systems. Step S98 also suitably formats the data to be used by traffic congestion avoidance and/or traffic routing systems.

Step S88 audibly announces the results. The greater the reliability rating that a given result has, the louder the synthetic voice will be, to a limit that is set by optional operator input (the input of which is not shown).

Some traffic lights are synchronized so their red to green transitions occur sequentially, allowing a vehicle traveling at a certain speed to move continuously without encountering a red light. The system determines if the predicted red to green transition for three successive intersections along the same street exhibit a time difference from intersection to intersection that is a linear function of the distance between the intersections along the route (linearity signifying a reasonable travel speed). For at least three adjacent intersections along a route meeting this linearity criteria, their carrier locations are segregated into a synchronized group. Conversely, for at least three intersections failing to meet this linearity criteria their carrier locations are segregated into an unsynchronized group.

For travel along synchronized lighting routes the system predicts which traffic lights will be green, and indicates a moving green zone on the display as a transparent overlay to the moving map coincidentally displayed. For locations where the anticipated outside traffic lights would be red, the overlay appears as moving zone of red overlaid on the underlying map. For areas that are not synchronized the user will see a blue overlay. For areas that are unknown, or insufficient information has been found to allow predictions, the display overlay remains clear (does not obscure). See FIGS. 12 and 13.

Conversely, the system can ascertain whether a certain signal light is unlikely a synchronized light, or a synchronized light that requires a vehicle to be on a pad prior to being able to actuate, or a light that is usually synchronized, but loses synchronization upon actuation of a pedestrian walk switch.

FIG. 10 shows an image that may be presented on a display interface such as display 18 of FIG. 1 or display 121 of FIG. 2. The light states in the neighborhood are indicated herein by colored triangles 612 on a number of linked intersections.

Referring to the alternate image of FIG. 11, the traffic light states are also annotated with a timing numbers 702, 706, 710, 714, 718, 720, and 722. indicating how long the traffic light is expected to remain in that state, based on available information. Also, small arrows 700, 704, 708, 712, 716, and 724 (also appearing in FIG. 10 as arrows 612) overlay the background moving map to indicate the light state. These zones are shown by small colored arrows, but could also be indicated by small colored numbers, or a combination of each. The colors may include a color from the set of other than red, green, yellow; for example, blue, which may indicate the state of not yet knowing what the light state is (a predetermined criteria for a low reliability rating). Any combination of these colors may be interspersed, in directions other than opposed.

Referring to FIGS. 12 and 13, for a sufficiently full data base zones of a constant synchronization state will appear to move against each other and the background as appropriate. To detect such synchronization, the system determines if the predicted red to green transition for at least three successive intersections along the same street exhibit a time difference from intersection to intersection that is a proportional to the distance between the intersections (i.e., essentially a linear function of distance along a route). If a spatially contiguous series of intersection locations along a route meet this criteria, they are placed into a synchronized group. The direction of synchronized traffic is shown on FIG. 13 as semitransparent colored arrows 628, 630 embracing a band 626A colored red to indicate a zone where traffic signals are red. Green colored band 626B is contiguous with arrow 628 and red colored band 626A, and these two spatially contiguous bands are part of a linear overlay marking a spatially contiguous series from the synchronized group. Each of the bands are considered spatially contiguous subgroups from the synchronized group.

One benefit of using the zone information is that it can permit routing choices using available information. This permits the EMS, police, fire protection services or commercial operator to potentially get into a moving green area, as opposed to getting into a red area. This involves making decisions based on available information. I.e. does the driver turn right, left (when he/she can) or wait the remaining time at the present intersection to achieve the desired result.

The displays may be overlaid with at least some of the information from other sources such as a network, or artificial satellite. This other information can be from many different sources including congestion information from external traffic information sources.

This system offers a prediction of information about the traffic state. This is based on previous information collected by the same vehicle, or otherwise. A typical installation exploits information that is collected into its self contained memory 14. This memory is then scanned in a “location lookup” fashion, i.e. it determines traffic signal in the area and as the unit approaches it extracts proximal stoppage locations and offers a prediction of the traffic light state; i.e. when the red light occurs. It therefore, through calculation using templates of many different routings through an area, can make a prediction of the best available routing based on an input variable, such as best time, or shortest distance with no red lights, or the shortest time with no red lights, exploiting right turns on red, or exploiting known “synchronized lights” paths. It can also offer information based on previous attempts correlated with the time, a, day of week, etc. and thereby offer an indication of phasing in the sequence of synchronized lights. For example, if the vehicle is just about to be given a red light, the driver might adjust speed. Alternatively, if a vehicle is just about to meet many sequential red lights—the driver can retard location in phase with other traffic, or recognize and follow the best speed to remain synchronized. This information can be displayed, and/or fed to advanced cruise control systems.

The system uses proximal information, in conjunction with location from an intersection to infer, for example, that a light must have been red since the vehicle was stopped 25 feet from the intersection. In such cases the system can make the prediction that the light must have been red at given time using rule-based information such as: because a car is x feet long, there must have been exactly one car between the vehicle and the intersection and therefore the light must have turned green on average y seconds ago. This can then be used as a slightly less weighted element of information to enhance the data set.

The upcoming intersection locations are evaluated to obtain the expected time of arrival of the vehicle at the stop line for known upcoming intersections.

Not all stops are due to traffic lights, and thus may be treated differently or even be excluded from the database. For example, a vehicle may stop for the purposes of: yield sign(s), stop sign(s), stop(s) to permit traffic to pass in directions of travel other than the user's. Stop sign locations are filtered out from further consideration as being locations that are proximal to similar locations where a stop always occurs. Stop sign locations can also optionally be filtered based on the amount of time the stop took place over. Many cases will involve only the obligatory minimum stop duration.

Moreover, a filter is also applied that filters out other singular or infrequent events, examining nearby or proximate locations when determining frequency. The aspect of considering as a group nearby or proximate locations is tailored to equate locations of several average vehicle lengths of each other and the appropriate number of inter-vehicle distances. With a broader view of proximity, stops that are rare or infrequent in a nearby vicinity will be rejected from further consideration.

The filter is wide enough spatially to recognize locations that are sufficiently close to each other as to qualify as a stoppage at the same traffic light, but yet tight enough to recognize a once-used location, such as the stoppage of a vehicle ahead to discharge a passenger, as distinct. Due to the fact that some traffic stopped at traffic lights necessitates stoppage behind a long line of cars, stoppage locations beyond a certain number of vehicles back from the stop line are of necessity disregarded or at least washed out with low weighting factors (a predetermined criteria for lowering the reliability rating). It is true that some locations partially along such a line of vehicles may also be used habitually for the discharge of passengers, these occurrences too can be somewhat filtered based on the increased randomness temporally. However it is further recognized that even these may also be influenced by the repetitive nature of the periodicity of the proximal traffic light.

Furthermore, periodicity of the lighting data points may be filtered for such and used for predictions, such as same time every day, same time in a week or same time of month, or some combination of same. i.e. same number or 70 second intervals after the second Tuesday of the month, as these become available.

Optionally further filtering permits passage for further processing, cases which have been pre-filtered (defined to be those cases above), the approximate location, within a few average vehicle lengths, and also extracts the direction of travel by taking the difference between location entries coming in from the navigational sensor, real time; i.e., it is filtering the present position, against all known stoppage locations in memory that were recorded moving in a like direction (optionally with a similar anticipated direction of departure, optionally taking into account of any inputs the user may have, i.e. if the user is telling the machine that a left turn lane is being used this can be used to refine/qualify the departure time data elements, or other related data output annunciation, display or otherwise).

Notwithstanding the foregoing filtering, the filtered cases may still be stored in a separate region of the non-volatile memory.

Vehicle Expected Time of Arrival (ETA) is extrapolated out several minutes of travel time along various alternate routes to gather from the database known intersections that are within this travel time and therefore the vehicle might traverse. The extracted upcoming intersection data may be optionally weighted with a higher reliability rating to increase the significance of the timing or importance of data collected at or towards the deduced (or prior known) stop line.

Using these upcoming intersections as destination, the historical travel time from the current location is derived from the difference between the respective arrival times that were previously stored. Departure time may be obtained from a TOFM or from green passage data. Arrival time may be obtained from TOLM or from green passage data. The smallest historical travel time is used to predict the ETA for each of the upcoming deduced intersections.

In some embodiments the time of day may warrant adding a delay offset to the predicted travel time through the intersection to account for any expected traffic, e.g. for travel during rush hour the system will expect the vehicle to be pushed back from the front of the stop line due to the presence of other traffic.

It is understood that in some cases at least one zone of synchronized lights is provided as an overlay to the moving map provided from a navigation system. It is understood that this could be an interface provided by a personal navigation device (PND), Personal Digital Assistant (PDA), or cellphone display.

It is anticipated that in place of a navigational sensor and processor, a personal navigation device (PND) can benefit from this technology, in order to predict stoppages associated from walk/don't walk signs. This can be further used in conjunction with a PND in a vehicle, data bases being separated by the maximum speed of the given trip being separated by a threshold. Trips are separated from each other by the detection of stoppages of a greater threshold such as for example, three minutes. Information output in this embodiment is displayed, or relayed to the user in audible fashion, perhaps via headphones. It is anticipated that this can be further incorporated into increasingly further levels of integration with other electronic devices.

Obviously, many modifications and variations of the present invention are possible in light of the above teachings. It is therefore to be understood that within the scope of the appended claims, the invention may be practiced otherwise than as specifically described.

1. A transit predictor to be carried by a carrier such as a person or vehicle when attempting to travel through one or more traffic signals that have a repeating change of state, the transit predictor comprising:
a data source having a navigational output indicating carrier location and a timing output indicating time; and
a processor with a memory, said processor being coupled to said data source for recording in said memory a plurality of background data from said data source signifying (a) one or more carrier locations where data from said data source indicate the carrier was substantially stationary, and (b) one or more times when data from said data source indicate the carrier ceased being substantially stationary, said processor being operable to algorithmically derive from said plurality of background data a predicted future event that will occur around a predicted time at a location where, according to said background data, said carrier previously ceased being substantially stationary.

2. A transit predictor according to claim 1 wherein said processor is operable to record in said memory among said plurality of background data one or more times when said navigational output and said timing output indicate the carrier became substantially stationary.

3. A transit predictor according to claim 2 comprising:
an interface for presenting to a user information about said predicted future event in the form of a prediction of when at least one of said one or more traffic signals will change state.

4. A transit predictor according to claim 2 wherein said processor is operable to algorithmically derive from said plurality of background data a plurality of times and locations for a plurality of predicted future events.

5. A transit predictor according to claim 1 wherein said processor is operable to fit into a periodic pattern at least some times from said background data that spatially correlate to equivalent ones of the carrier locations, said periodic pattern having times separated by multiples of a postulated cycle time.

6. A transit predictor according to claim 5 wherein said processor is operable to derive said postulated cycle time by:
(a) selecting time pairs from said background data, restricting selections to times that correlate to equivalent ones of the carrier locations, and
(b) calculating a time difference between times of each selected time pair and normalizing the time difference by effectively dividing it by the greatest integer producing a normalized shift having a magnitude of less than twenty four hours.

7. A transit predictor according to claim 6 wherein said processor is operable to derive said postulated cycle time by:
(a) for each normalized shift, selecting from said background data a plurality of test times that correlate to carrier locations associated with said normalized shift, and
(b) determining if pairs of said test times differ approximately by an integer multiple of the normalized shift, in order to determine a consistency rating for said normalized shift.

8. A transit predictor according to claim 7 wherein said processor is operable to record in said memory among said plurality of background data one or more times when said navigational output and said timing output indicate the carrier became substantially stationary, said processor being operable to derive said postulated cycle time by:
(a) for spatially correlated ones of said carrier locations in said background data, finding a maximum duration during which the carrier remained substantially stationary, and
(b) for each pair of test times, determining if a first one of the test times substantially precedes by less than the maximum duration, a time obtained by arithmetically combining a second one of said test times and an integer multiple of the normalized shift, in order to determine the consistency rating for the normalized shift.

9. A transit predictor according to claim 5 wherein said processor is operable to
(a) fetch from said background data nearby carrier locations within a predetermined distance from a carrier location provided currently by said navigational output, and
(b) calculate an estimated time of arrival for at least some of said nearby carrier locations.

10. A transit predictor according to claim 4 wherein said processor is operable using predetermined criteria to calculate a reliability rating for locations associated with the plurality of predicted future events.

11. A transit predictor according to claim 10 comprising:
an interface for presenting to a user information about the plurality of predicted events in the form of one or more predictions of when said one or more traffic signals will change state, together with information about the reliability rating for one or more locations associated with said plurality of predicted future events.

12. A transit predictor according to claim 2 wherein said interface presents information about the reliability rating for one or more locations associated with said plurality of predicted future events in the form of at least one of (a) a visible signal, (b) a color coded visible signal, (c) an audible signal, and (d) an audible signal with an intensity correlated to the reliability rating.

13. A transit predictor according to claim 2 wherein said data source comprises:
a global positioning satellite system for providing said navigational output in the form of latitude and longitude.

14. A transit predictor according to claim 2 wherein said data source comprises one or more of a global positioning satellite system, an inertial navigational reference, a LORAN sensor, an Omega navigation system sensor, and an RNAV receiver.

15. A transit predictor according to claim 1 wherein said data source comprises:
a device for receiving information from a cellphone infrastructure in order to produce by triangulation said navigational output.

16. A transit predictor according to claim 1 wherein said data source has a first device for providing said navigational output and a second device for independently providing said timing output.

17. A transit predictor according to claim 1 wherein said processor compares successive data from said navigational output to calculate and store a value corresponding to carrier direction.

18. A transit predictor according to claim 1 wherein said processor is operable to store in memory from said data source one or more measured pairs, each member of each pair having a location value and a time value substantially coincident with a change in a carrier state of being substantially stationary.

19. A transit predictor according to claim 18 wherein said one or more measured pairs are divided into one or more intersection groups wherein members from the same one of said one or more intersection groups have a location value that is substantially equivalent to within a predetermined tolerance.

20. A transit predictor according to claim 1 wherein said processor is operable to store in memory one or more measured triplets, each having a location value and two time values corresponding to a commencement and conclusion of an interval wherein the carrier is substantially stationary.

21. A transit predictor according to claim 1 comprising:
a user operable device enabling a user to convey to said processor one or more observations that are compared by said processor with data from said data source in order to refine at least a contemporaneous one of said plurality of background data for said memory.

22. A transit predictor according to claim 21 wherein said user operable device is operable to convey to said processor a time that one of said one or more traffic signals changed state.

23. A transit predictor according to claim 21 wherein said user operable device is operable to convey a time that one of said one or more traffic signals provided a signal permitting non-turning departure.

24. A transit predictor according to claim 23 wherein said user operable device is operable to convey a time that one of said one or more traffic signals provided a signal permitting turning departure.

25. A transit predictor according to claim 1 comprising:
a two dimensional display showing intersections annotated with information about said predicted future event.

26. A transit predictor according to claim 25 wherein said processor is operable to algorithmically derive from said plurality of background data a plurality of times and locations for a plurality of predicted future events, said display being annotated with information about said plurality of predicted future events distributed at spaced positions.

27. A transit predictor according to claim 4 wherein said processor is operable to calculate whether a synchronized group selected from the plurality of predicted future events are synchronized to have times of occurrence that approximate a linear function of distance along a route, said synchronized group being at least three in number.

28. A transit predictor according to claim 27 comprising:
a two dimensional display showing a plurality of linked intersections, some of the linked intersections being displayed as an uninterrupted route that is overlaid with a linear overlay and marks a spatially contiguous series from the synchronized group.

29. A transit predictor according to claim 28 wherein said linear overlay is colored to distinguish at least part of the spatially contiguous series that has the same state, said processor updates and linearly adjusts said overlay to account for state changes within the spatially contiguous series.

30. A transit predictor according to claim 29 wherein said linear overlay has differently colored bands joined end to end in order to segregate the spatially contiguous series into spatially contiguous subgroups distinguished by having the same state and color.

31. A transit predictor according to claim 30 wherein said processor is operable to calculate whether an unsynchronized group from the plurality of predicted future events have times of occurrence that cannot be approximated as a linear function of distance along a route, said synchronized group being at least three in number.

32. A transit predictor according to claim 3 comprising:
a power sensor coupled to said processor for signaling thereto a decline in power supplied to said processor, said memory having a volatile section and a non-volatile section, said processor being operable in response to signaling from said power sensor to transfer data from the volatile section to the non-volatile section of said memory.

33. A transit predictor according to claim 1 comprising:
a wireless transceiver coupled to said processor for establishing communications with an external network, said processor being operable to download from said network at least one of: (a) supplementary data that can be used to supplement the background data, and (b) a schedule of state changes for said one or more traffic signals.

34. A transit predictor according to claim 33 wherein said processor is operable to upload to said network at least one of: (a) time and location of said predicted event, (b) at least a portion of said background data, and (c) information derived from said background data.

35. A predictive method employing a memory for use with a carrier such as a person or vehicle when attempting to travel through one or more traffic signals that have a repeating change of state, the method including the steps of:
recurrently providing a navigational output indicating carrier location;
recurrently providing a timing output indicating time;
using said navigational and said timing outputs, recording in said memory a plurality of background data signifying (a) one or more carrier locations where the carrier was substantially stationary, and (b) one or more times when the carrier ceased being substantially stationary; and
algorithmically deriving from said plurality of background data a predicted future event that will occur around a predicted time at a location where, according to said background data, said carrier previously ceased being substantially stationary.

36. A predictive method according to claim 35 comprising the step of:
recording in said memory among said plurality of background data one or more times when said navigational output and said timing output indicate the carrier became substantially stationary.

37. A predictive method according to claim 36 comprising:
presenting to a user information about said predicted future event in the form of a prediction of when at least one of said one or more traffic signals will change state.

38. A predictive method according to claim 36 comprising the step of:
algorithmically deriving from said plurality of background data a plurality of times and locations for a plurality of predicted future events.

39. A predictive method according to claim 35 comprising the step of:
fitting into a periodic pattern at least some times from said background data that correlate to equivalent ones of the carrier locations, said periodic pattern having times separated by multiples of a postulated cycle time.

40. A predictive method according to claim 39 wherein said postulated cycle time is derived by:
selecting time pairs from said background data, restricting selections to times that correlate to equivalent ones of the carrier locations, and
calculating a time difference between times of each selected time pair and normalizing the time difference by effectively dividing it by the greatest integer producing a normalized shift having a magnitude of less than twenty four hours.

41. A predictive method according to claim 40 wherein said postulated cycle time is derived by:
for each normalized shift, selecting from said background data a plurality of test times that correlate to carrier locations associated with said normalized shift, and
determining if pairs of said test times differ approximately by an integer multiple of the normalized shift, in order to determine a consistency rating for said normalized shift.

42. A predictive method according to claim 41 comprising the step of:
recording in said memory among said plurality of background data one or more times when said navigational output and said timing output indicate the carrier became substantially stationary, said postulated cycle time being derived by:
for spatially correlated ones of said carrier locations in said background data, finding a maximum duration during which the carrier remained substantially stationary, and
for each pair of test times, determining if a first one of the test times substantially precedes by less than the maximum duration, a time obtained by arithmetically combining a second one of said test times and an integer multiple of the normalized shift, in order to determine the consistency rating for the normalized shift.

43. A predictive method according to claim 39 comprising the steps of:
fetching from said background data nearby carrier locations within a predetermined distance from a carrier location provided currently by said navigational output, and
calculating an estimated time of arrival for at least some of said nearby carrier locations.

44. An arrangement for a carrier that attempts intersection crossings exploiting GPS for time and position information, supplements data and timing information with network data, shares data with network elements, collects, filters, with artificial intelligence, deduces meta information, annunciates, annotates on a display, proximal and subsequeal, including projected light phase, remaining time, synchronizing aspects including publishable speed to be made good to make the next green phase, traffic implications thereof, high reliability deductions in conventional traffic light colors of amber, red, green and less than reliable information in non-conventional colors such as blue, and removing such colors a slight time prior to state change, for the present intersection.
